(19) United States
(12) Patent Application Publication
(10) Pub. No.: US 2026/0217017 A1
(43) Pub. Date: Jul. 30, 2026

(54) Layer Transfer Device

(71) Applicant: Brother Kogyo Kabushiki Kaisha, Nagoya (JP)

(72) Inventors: Yusuke Ikegami, Nagoya (JP); Tomoya Ichikawa, Nagoya (JP)

(21) Appl. No.: 19/571,818

(22) Filed: Mar. 19, 2026

Related U.S. Application Data
(63) Continuation of application No. PCT/JP2024/029975, filed on Aug. 23, 2024.

(30) Foreign Application Priority Data
Sep. 21, 2023 (JP) 2023-154112
Nov. 30, 2023 (JP) 2023-202803

(51) Int. Cl. B41F 16/00; B65H 41/00

(52) U.S. Cl. CPC B41F 16/006; B41F 16/0026; B65H 41/00; B65H 2801/12

(57) ABSTRACT

A layer transfer device includes: a housing body; a first supply reel detachably attached to the housing body, the first supply reel including a winding core around which a film is wound, the film including a first base layer, a first release layer formed on the first base layer, and a viscoelastic layer formed on the first release layer; a take-up reel configured to take up the film supplied from the first supply reel; a motor configured to drive the take-up reel; and a transfer unit including a heating rotating member and configured to overlay a sheet including a second base layer and a printed layer printed on the second base layer on the film supplied from the first supply reel, and heat the sheet with the heating rotating member to transfer the viscoelastic layer of the film to the printed layer of the sheet.

### SPECIFICATION

### REFERENCE TO RELATED APPLICATIONS

This is a continuation application of International Application No. PCT/JP2024/029975 filed on August 23, 2024, which claims priority from Japanese Patent Applications No. 2023-154112 filed on September 21, 2023 and No. 2023-202803 filed on November 30, 2023. The entire contents of the aforementioned applications are incorporated herein by reference.

### BACKGROUND ART

There is known a layer transfer device in which a second sheet having a base layer and a viscoelastic layer is superimposed on a first sheet on which a printed layer such as a toner image is formed, the two sheets are heated and pressed, and the viscoelastic layer is transferred to the printed layer by peeling off the base layer of the second sheet after the viscoelastic layer is pressure-bonded. After the viscoelastic layer of the second sheet is pressure-bonded onto the printed layer of the first sheet by the layer transfer device, the printed layer to which the viscoelastic layer has been transferred is transferred onto a fabric such as a T-shirt by a pressing machine.

However, in the layer transfer device of the related art, after the viscoelastic layer is pressure-bonded onto the printed layer of the first sheet, a user needs to manually peel off the base layer, and the peeling work is a time-consuming process. In addition, there is a possibility that manual peeling may fail.

### SUMMARY

Therefore, an object of the present invention is to eliminate the effort required for a user to peel off the base layer that has been supporting the viscoelastic layer when transferring the viscoelastic layer to the printed layer of the sheet.

In order to solve the above problem, a layer transfer device according to the present invention includes: a housing body; a first supply reel detachably attached to the housing body, the first supply reel including a winding core around which a film is wound, the film including a first base layer, a first release layer formed on the first base layer, and a viscoelastic layer formed on the first release layer; a take-up reel configured to take up the film supplied from the first supply reel; a motor configured to drive the take-up reel; and a transfer unit including a heating rotating member and configured to overlay a sheet including a second base layer and a printed layer printed on the second base layer on the film supplied from the first supply reel, and heat the sheet with the heating rotating member to transfer the viscoelastic layer of the film to the printed layer of the sheet.

### BRIEF DESCRIPTION OF THE DRAWINGS

FIG. 1A is a diagram illustrating a layer transfer device, and FIG. 1B is a cross-sectional view illustrating a configuration of a foil film.

FIG. 2 is a diagram illustrating a state where a cover of the layer transfer device is opened.

FIG. 3 is a front view of a pressure roller and a heating roller.

FIG. 4A is a perspective view illustrating a film cartridge with a foil film wound thereon, and FIG. 4B is a perspective view illustrating a film cartridge with a viscoelastic layer film wound thereon.

FIGS. 5A, 5B, and 5C are diagrams illustrating timings of pressure contact and separation in a foil save mode.

FIG. 6A is a view of a film cartridge and a transfer unit as viewed from an axial direction, and FIG. 6B is an enlarged cross-sectional view of the viscoelastic layer film within a broken line in FIG. 6A.

FIG. 7A is a cross-sectional view of a sheet on which a printed layer is formed and a foil film, FIG. 7B is a cross-sectional view of a state in which the sheet is pressed against the foil film, and FIG. 7C is a cross-sectional view illustrating a state in which a base layer of the foil film is peeled off from the sheet.

FIG. 8 is a flowchart illustrating a procedure of transferring a printed layer to a fabric using a transfer printing sheet.

FIG. 9A is a cross-sectional view of a transfer printing sheet on which a printed layer is formed and a viscoelastic layer film, FIG. 9B is a cross-sectional view of a state in which the viscoelastic layer film is pressed against the transfer printing sheet, and FIG. 9C is a cross-sectional view illustrating a state in which a base layer of the viscoelastic layer film is peeled off from the transfer printing sheet.

FIG. 10 is a graph illustrating a relationship between peeling force and temperature of a first release layer and a second release layer.

FIG. 11A is a cross-sectional view illustrating a state in which a transfer printing sheet to which a viscoelastic layer is transferred is pressed against a fabric, and FIG. 11B is a cross-sectional view illustrating a state after the transfer printing sheet is peeled off from the fabric to which the printed layer is transferred.

FIG. 12 is a diagram illustrating a layer transfer device including a fan.

FIG. 13A is a diagram illustrating a layer transfer device, and FIG. 13B is a cross-sectional view illustrating a configuration of a foil film.

FIG. 14 is a diagram illustrating a state where a cover of the layer transfer device is opened.

FIG. 15 is a flowchart illustrating the operation of a controller.

FIG. 16 is a flowchart illustrating a fan driving process.

FIG. 17A is a diagram illustrating a step of conveying a sheet toward a gap between a heating roller and a pressure roller, and FIG. 17B is a diagram illustrating a step of temporarily stopping the conveyance of the sheet.

FIG. 18A is a diagram illustrating a step of switching the heating roller and the pressure roller from a separated state to a pressure state, and FIG. 18B is a diagram illustrating a step of resuming the conveyance of the sheet.

FIG. 19A is a diagram illustrating a state in which a trailing end of the sheet is positioned between a nip portion and a peeling shaft, and FIG. 19B is a diagram illustrating a step of switching the heating roller and the pressure roller to the separated state after the trailing end of the sheet has passed the peeling shaft.

FIG. 20 is a diagram illustrating a layer transfer device.

FIG. 21A is a diagram illustrating a step of conveying a sheet toward a gap between a heating roller and a pressure roller, and FIG. 21B is a diagram illustrating a step of temporarily stopping the conveyance of the sheet.

FIG. 22A is a diagram illustrating a step of switching the heating roller and the pressure roller from a separated state to a pressure state, and FIG. 22B is a diagram illustrating a step of resuming the conveyance of the sheet.

FIGS. 23A and 23B are diagrams illustrating a step of switching the heating roller and the pressure roller to the separated state after a trailing end of the sheet has passed a peeling claw.

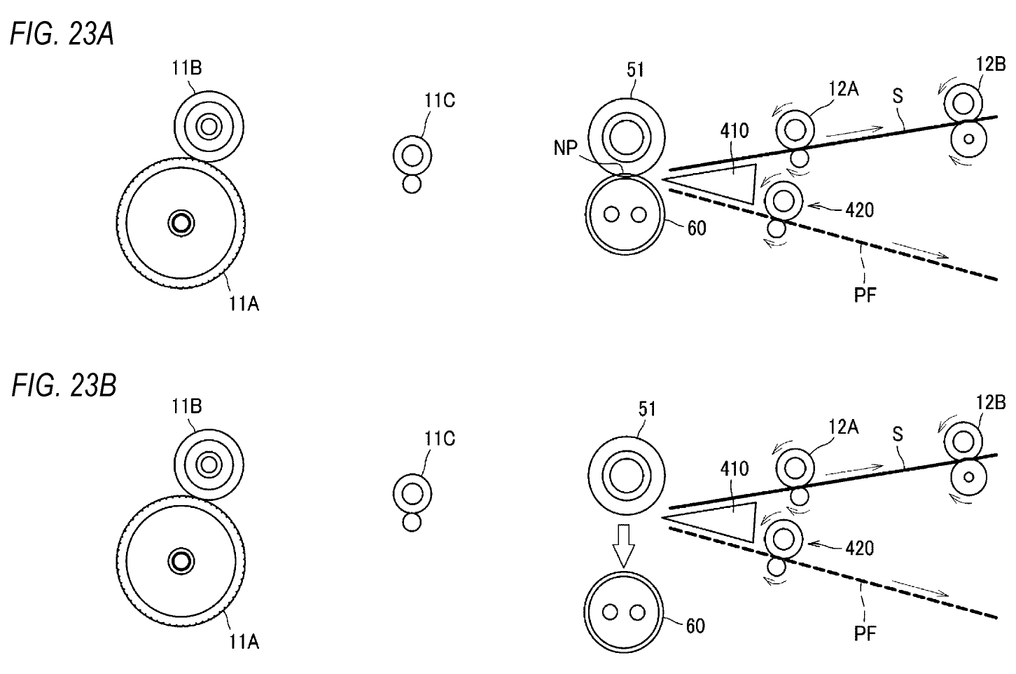

### DESCRIPTION

Next, a first embodiment will be described in detail with reference to the drawings as appropriate.

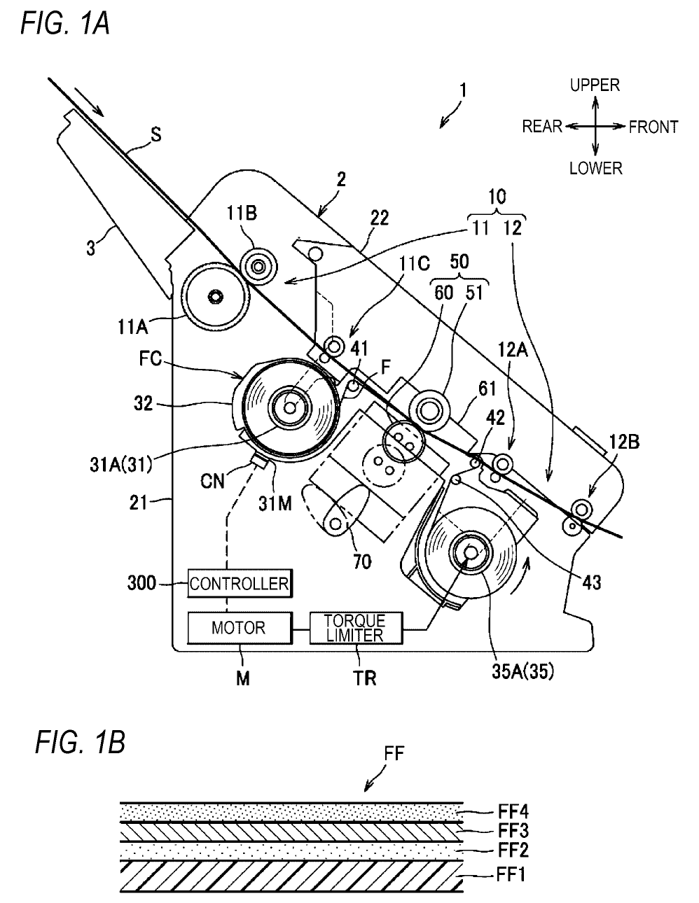

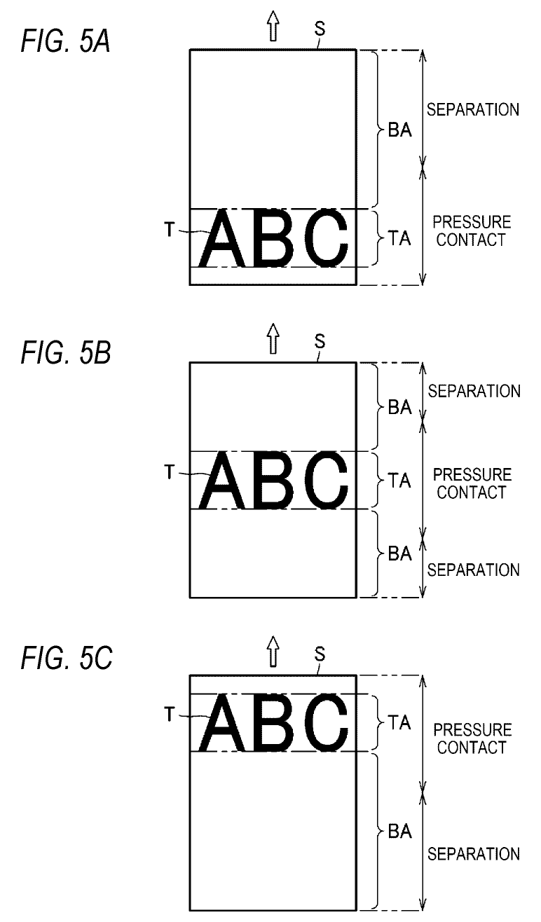

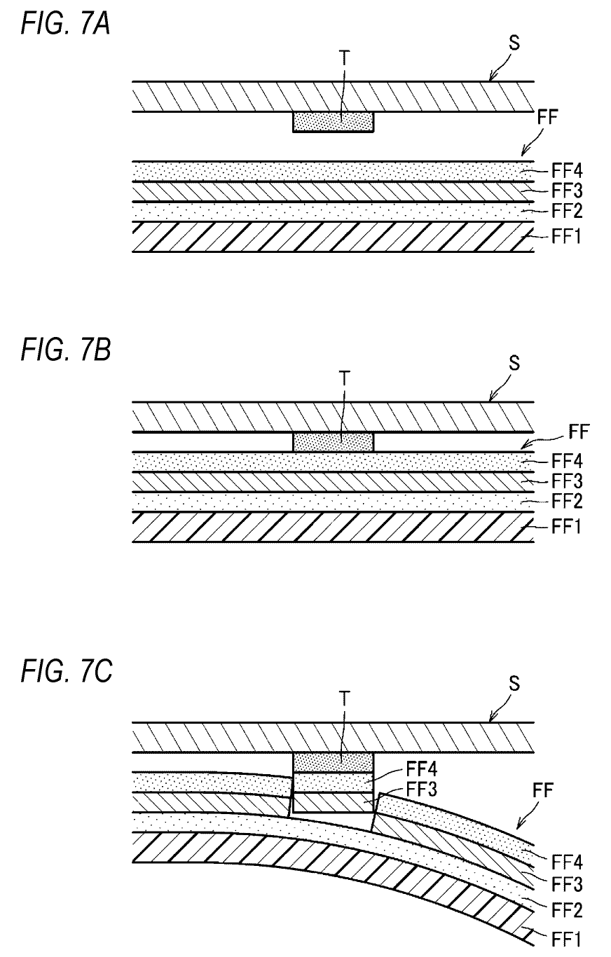

As illustrated in FIG. 1A, a layer transfer device 1 is a device that overlays a sheet S on a film F including a plurality of layers and transfers a layer of the film F to a printed layer T of the sheet S (see FIGS. 5A to 5C and 7A to 7C for the printed layer T). For example, the layer transfer device 1 forms a printed layer T such as a toner image on a sheet S by an image forming device such as a laser printer, and then transfers a layer such as a foil or a viscoelastic layer onto the printed layer T of the sheet S. The layer transfer device 1 includes a housing 2, a sheet tray 3, a sheet conveying unit 10, a film supply unit 30, a transfer unit 50, a motor M, a torque limiter TR, an electrical contact CN, and a controller 300.

The housing 2 is made of resin or the like and includes a housing body 21 and a cover 22.

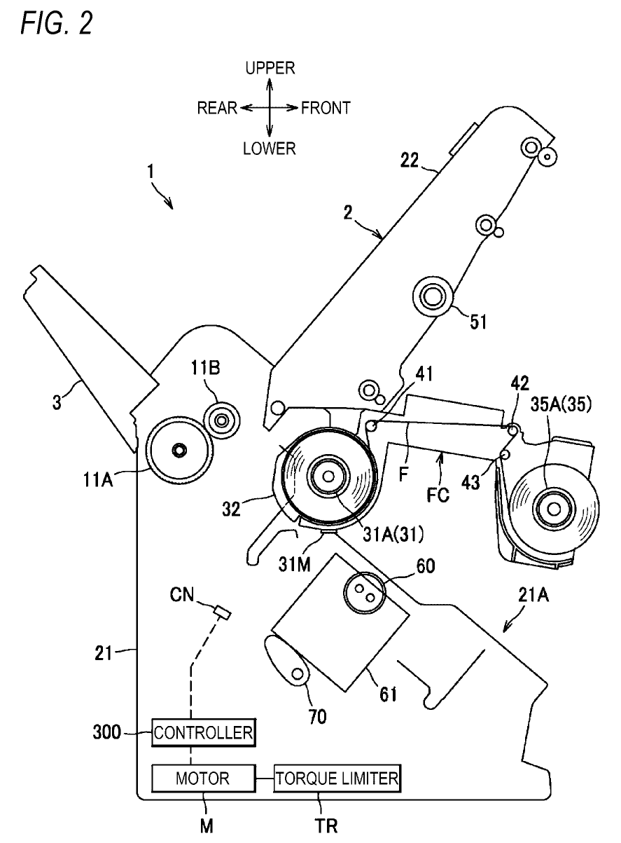

The housing body 21 has an opening 21A (see FIG. 2) in an upper portion thereof. The opening 21A is an opening for attaching and detaching a film cartridge FC, which will be described later, to and from the housing body 21.

The cover 22 is a member for opening and closing the opening 21A. A rear end portion of the cover 22 is supported by the housing body 21 in a rotatable manner. The cover 22 is rotatable between a closed position (position in FIG. 1A) where the opening 21A is closed and an open position (position in FIG. 2) where the opening 21A is opened.

The sheet tray 3 is a tray on which a sheet S such as paper sheets and OHP films are set. The sheet tray 3 is provided at a rear portion of the housing 2. The sheet S is set on the sheet tray 3 with a surface on which the printed layer T is formed facing downward.

The sheet conveying unit 10 includes a sheet supply mechanism 11 and a sheet discharge mechanism 12.

The sheet supply mechanism 11 is a mechanism that conveys the sheet S on the sheet tray 3 one by one toward the transfer unit 50. The sheet supply mechanism 11 includes a pickup roller 11A, a retard roller 11B, and an upstream side conveying roller 11C as a conveying roller.

The pickup roller 11A is a roller that picks up the sheet S set on the sheet tray 3. The retard roller 11B separates the sheets S conveyed by the pickup roller 11A into one sheet.

The upstream side conveying roller 11C is made up of two rollers, and the sheet S can be conveyed by rotating the rollers in a state where the sheet S is sandwiched between these rollers. The upstream side conveying roller 11C is a conveying roller disposed immediately before the transfer unit 50 in a conveying direction of the sheet S.

The sheet discharge mechanism 12 is a mechanism that discharges the sheet S that has passed through the transfer unit 50 to the outside of the housing 2. The sheet discharge mechanism 12 includes a downstream side conveying roller 12A and a discharge roller 12B. The downstream side conveying roller 12A and the discharge roller 12B are each made up of two rollers, and the sheet S can be conveyed by rotating the rollers in a state where the sheet S is sandwiched between these rollers.

The film supply unit 30 is a portion that supplies the film F so as to overlay the sheet S conveyed from the sheet supply mechanism 11. The film supply unit 30 includes the film cartridge FC.

As shown in FIG. 2, the film cartridge FC is attachable to and detachable from the housing body 21 through the opening 21A in a direction orthogonal to an axial direction of a supply reel 31 to be described later. In the following description, the axial direction of the supply reel 31 is simply referred to as "axial direction". The film cartridge FC includes the supply reel 31, a take-up reel 35, a first guide shaft 41, a second guide shaft 42, and a third guide shaft 43. The film F is wound around the supply reel 31 of the film cartridge FC.

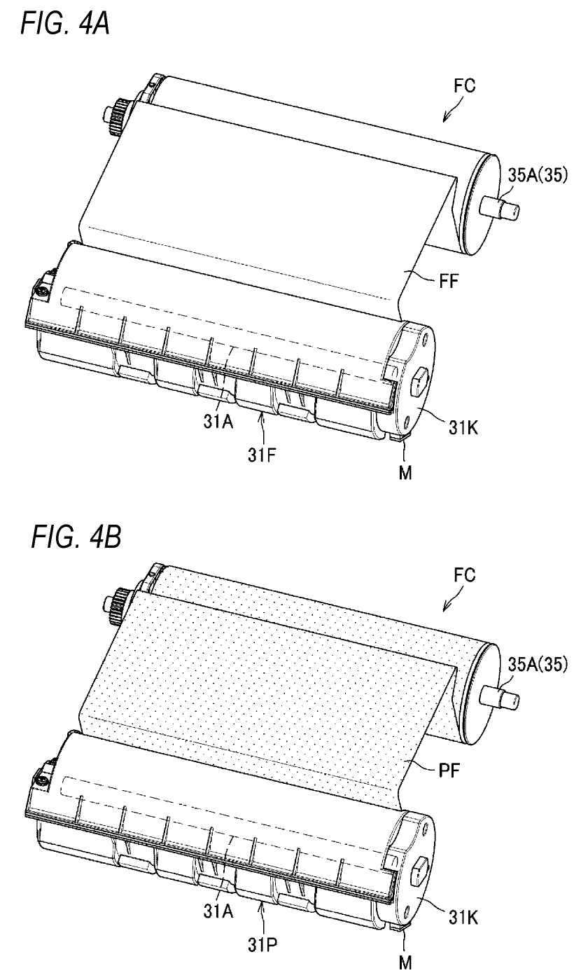

The layer transfer device 1 transfers different materials depending on the type of the film F wound around the film cartridge FC. For example, a foil film FF is a film that contains a foil and is used to transfer the foil to the printed layer T. A viscoelastic layer film PF is a film includes a viscoelastic layer PF3 and is used to transfer the viscoelastic layer PF3. In the present specification, as shown in FIG. 4B, the supply reel 31 around which the viscoelastic layer film PF is wound is referred to as a first supply reel 31P. As shown in FIG. 4A, the supply reel 31 around which the foil film FF is wound is referred to as a second supply reel 31F. That is, in the layer transfer device 1, the first supply reel 31P may be attached to the housing body 21, and the second supply reel 31F may be attached to the housing body 21 instead of the first supply reel 31P.

As illustrated in FIG. 1B, the foil film FF includes a foil base layer FF1, a foil release layer FF2, a foil transfer layer FF3, and a foil adhesive layer FF4. The foil release layer FF2 is formed on the foil base layer FF1. The foil transfer layer FF3 is formed on the foil release layer FF2. The foil adhesive layer FF4 is formed on the foil transfer layer FF3.

The foil base layer FF1 is a tape-shaped transparent base material made of a polymer material, and supports the foil release layer FF2, the foil transfer layer FF3, and the foil adhesive layer FF4.

The foil release layer FF2 is a layer for facilitating peeling of the foil transfer layer FF3 from the foil base layer FF1, and is disposed between the foil base layer FF1 and the foil transfer layer FF3. The foil release layer FF2 contains a transparent material, such as a wax-based resin, that is easily peeled off from the foil base layer FF1.

The foil transfer layer FF3 is a layer to be transferred to the printed layer T and includes a foil. The foil is a thin metal such as gold, silver, copper, or aluminum. The foil transfer layer FF3 may contain a coloring material such as gold, silver, or red, and a thermoplastic resin. The foil transfer layer FF3 is disposed between the foil release layer FF2 and the foil adhesive layer FF4.

The foil adhesive layer FF4 is a layer for adhering the foil transfer layer FF3 to the printed layer T. The foil adhesive layer FF4 contains a material that easily adheres to the printed layer T heated by the transfer unit 50, for example, a vinyl chloride resin or an acrylic resin.

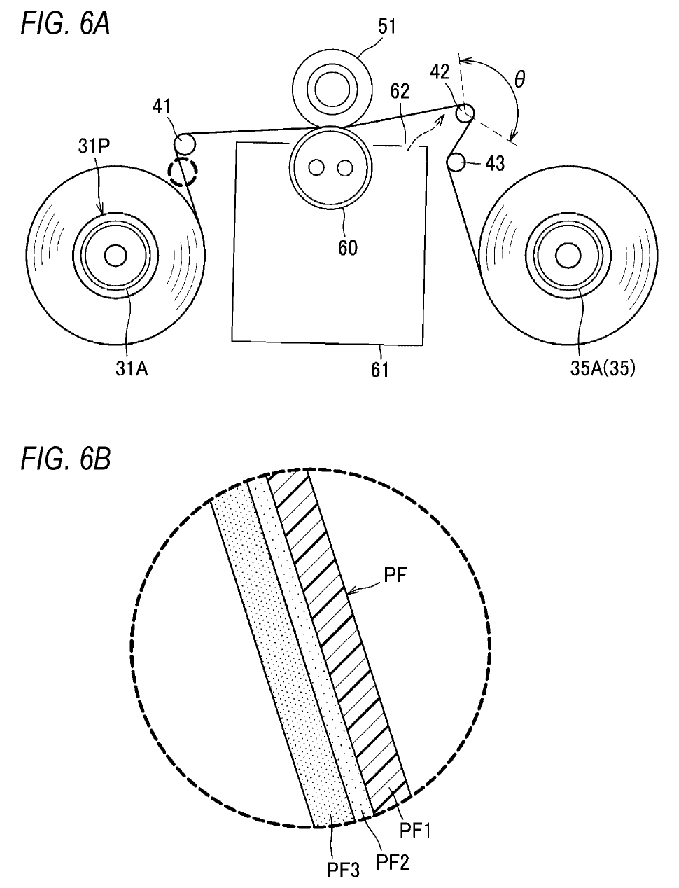

As shown in FIG. 6B, the viscoelastic layer film PF has a first base layer PF1, a first release layer PF2, and a viscoelastic layer PF3. The first release layer PF2 is formed on the first base layer PF1. The viscoelastic layer PF3 is formed on the first release layer PF2.

The first base layer PF1 supports the first release layer PF2 and the viscoelastic layer PF3. In the present embodiment, the first base layer PF1 is made of polyethylene terephthalate (PET) and has a thickness of 15 μm to 20 μm.

The first release layer PF2 is a layer for facilitating peeling of the viscoelastic layer PF3 from the first base layer PF1, and is disposed between the first base layer PF1 and the viscoelastic layer PF3. The first release layer PF2 contains a transparent material, such as a wax-based resin, that is easily peeled off from the first base layer PF1. In the present embodiment, a thickness of the first release layer PF2 is 10 μm to 15 μm.

The viscoelastic layer PF3 is a layer to be transferred to the printed layer T and contains a viscoelastic material. The viscoelastic material is a material made of a polymer material and having viscoelasticity. The viscoelastic layer PF3 is a material that easily adheres to the printed layer T heated by the transfer unit 50, and also a material that easily adheres to a transfer target such as a fabric. The viscoelastic layer PF3 contains, for example, a vinyl chloride resin or an acrylic resin, and any material suitable for adhesion to the transfer target may be selected. The viscoelastic layer PF3 is disposed on a surface of the viscoelastic layer film PF. The viscoelastic layer PF3 is thicker than the first release layer PF2. The thickness of the viscoelastic layer PF3 is 20 μm to 50 μm. Preferably, the thickness of the viscoelastic layer PF3 is 30 μm to 40 μm.

As shown in FIGS. 6A and 6B, the viscoelastic layer film PF is wound around the first supply reel 31P so that the viscoelastic layer PF3 faces a winding core 31A of the first supply reel 31P. That is, in a state where the viscoelastic layer film PF is wound around the first supply reel 31P, the viscoelastic layer PF3 is positioned inside the first base layer PF1.

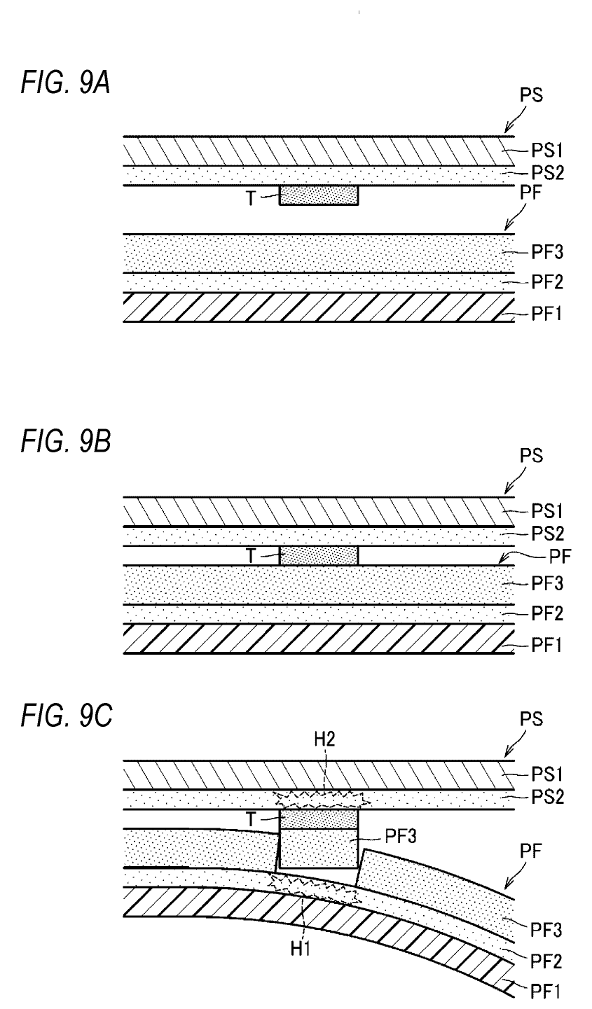

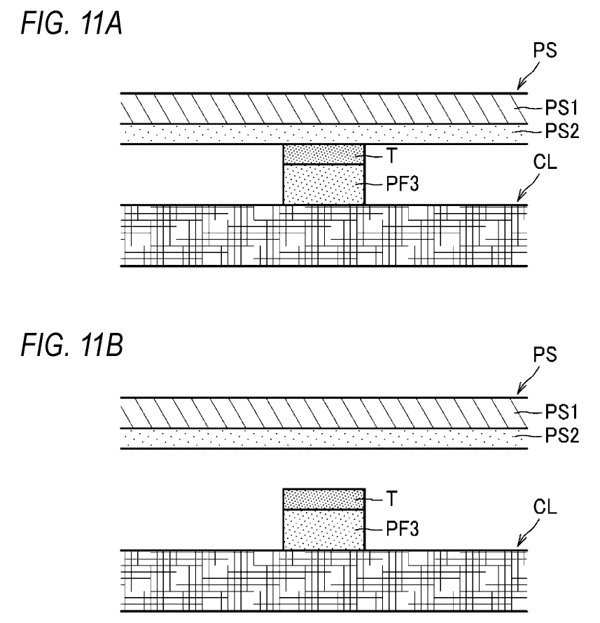

As illustrated in FIG. 9A, and FIGS. 11A and 11B, since it is difficult to print directly on a fabric CL using an image forming device, the printed layer T is printed on a transfer printing sheet PS, and then the printed layer T printed on the transfer printing sheet PS is transferred to the fabric CL. At this time, in order to prevent the printed layer T transferred to the fabric CL from being easily peeled off, the viscoelastic layer PF3 is transferred onto the printed layer T printed on the transfer printing sheet PS, and the printed layer T and the viscoelastic layer PF3 are transferred to the fabric CL. A transfer target to which the printed layer T is to be transferred using the transfer printing sheet PS is not limited to the fabric CL material, and may be leather, ceramics, wood, resin, metal, or other materials. The transfer target is not limited to a planar object and may be a three-dimensional object.

As shown in FIG. 9A, the transfer printing sheet PS has a second base layer PS1 and a second release layer PS2. The second release layer PS2 is formed on the second base layer PS1.

The second base layer PS1 is a tape-shaped transparent base material made of a polymer material, and supports the second release layer PS2. In the present embodiment, the second base layer PS1 is made of polyethylene terephthalate (PET) and has a thickness of 15 μm to 20 μm.

The second release layer PS2 is a layer on which the printed layer T is to be formed by an image forming device or the like. The second release layer PS2 is a layer that supports the printed layer T and the viscoelastic layer PF3 after the viscoelastic layer PF3 is transferred onto the printed layer T formed on the second release layer PS2, and makes it easier to peel the printed layer T and the viscoelastic layer PF3 from the second base layer PS1 when transferring the printed layer T and the viscoelastic layer PF3 onto the fabric CL or the like. The second release layer PS2 contains a transparent material, such as a wax-based resin, that is easily peeled off from the second base layer PS1. In the present embodiment, a thickness of the second release layer PS2 is 10 μm to 15 μm.

Here, as shown in FIGS. 9B and FIG. 9C, at a first temperature T1 which is a temperature at which the first base layer PF1 can be peeled off from the viscoelastic layer PF3, a first peeling force H1 of the first release layer PF2, which is a force required to peel off the first base layer PF1 from the viscoelastic layer PF3, is smaller than a second peeling force H2 of the second release layer PS2, which is a force required to peel off the second base layer PS1 from the printed layer T (H1 < H2).

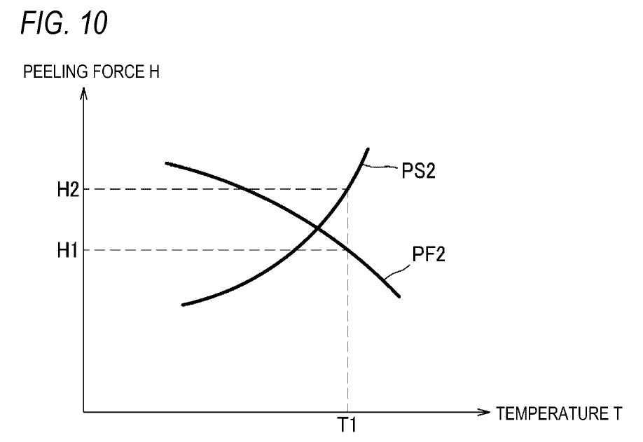

As shown in FIG. 10, the peeling forces of the first release layer PF2 and the second release layer PS2 is temperature dependent. The peeling force of the first release layer PF2 increases as the temperature decreases, and the peeling force decreases as the temperature increases. The peeling force of the second release layer PS2 decreases as the temperature decreases, and the peeling force increases as the temperature increases. In the present embodiment, the temperature at a peeling position is set to the first temperature T1 at which the first peeling force H1 of the first release layer PF2 is smaller than the second peeling force H2 of the second release layer PS2.

As shown in FIG. 1A, the supply reel 31 is attachable to and detachable from the housing body 21. The supply reel 31 is made of a resin or the like, and includes the winding core 31A, a supply case 31K, and a memory 31M.

One end of the film F is fixed to the winding core 31A, and the film F is wound around the winding core 31A. The supply case 31K is a hollow case that has a cylindrical shape and accommodates the film F wound around the winding core 31A.

The memory 31M is disposed at a lower end of the supply case 31K. When the supply reel 31 is attached to the housing body 21, the memory 31M is in contact with the electrical contact CN of the housing body 21. The memory 31M stores information on the film F wound around the supply reel 31.

The take-up reel 35 is a reel that takes up the film F supplied from the supply reel 31. The take-up reel 35 is made of resin or the like, and has a take-up shaft portion 35A. The other end of the film F is fixed to the winding shaft portion 35A. The motor M drives the take-up reel 35. The take-up reel 35 takes up the film F by being rotationally driven by the motor M.

The torque limiter TR limits the torque of a driving force supplied from the motor M to the take-up reel 35. In the present embodiment, the torque limiter TR applies, to the take-up reel 35, torque of a magnitude large enough to peel off the first base layer PF1 from the viscoelastic layer PF3.

The first guide shaft 41 is a shaft for changing a traveling direction of the film F drawn out from the supply reel 31. The second guide shaft 42 is a shaft for changing the traveling direction of the film F guided by the first guide shaft 41. The third guide shaft 43 is a shaft that changes the traveling direction of the film F guided by the second guide shaft 42 and guides the film F to the take-up reel 35.

The first guide shaft 41 guides the film F drawn out from the supply reel 31 so as to overlap from below with the sheet S, which is being conveyed with the printed layer T facing downward. The first guide shaft 41 changes a conveying direction of the film F drawn out from the supply reel 31 and guides the film F in a direction substantially parallel to the conveying direction of the sheet S.

The second guide shaft 42 is an example of a peeling shaft. The second guide shaft 42 comes into contact with the film F that has passed through the transfer unit 50, and changes the conveying direction of the film F that has passed through the transfer unit 50 to a direction different from the conveying direction of the sheet S. The film F, which has passed through the transfer unit 50 and is conveyed in a state of overlapping the sheet S, is guided in a direction different from that of the sheet S when passing through the second guide shaft 42, and is peeled off from the sheet S. In the following description, a position where the film F is peeled off from the sheet S is referred to as the "peeling position". In the present embodiment, the position of the second guide shaft 42 is the peeling position.

When the foil film FF is attached to the housing body 21, the second guide shaft 42 guides the foil base layer FF1 of the foil film FF that has passed through the transfer unit 50 in a direction different from the conveying direction of the sheet S.

When the viscoelastic layer film PF is attached to the housing body 21, the second guide shaft 42 guides the first base layer PF1 of the viscoelastic layer film PF that has passed through the transfer unit 50 in the direction different from the conveying direction of the sheet S.

As shown in FIG. 6A, a wrapping angle θ of the film F around the second guide shaft 42 is an obtuse angle. Specifically, the wrapping angle θ of the film F around the second guide shaft 42 is 120° to 140°. The radius of curvature of the second guide shaft 42 at a portion where the film F is wrapped is 1 mm to 3 mm.

The transfer unit 50 is a portion for transferring a layer onto the printed layer T formed on the sheet S by overlaying the sheet S on the film F being conveyed from the supply reel 31 toward the take-up reel 35, and applying heat and pressure while the sheet S and the film F are sandwiched.

When the foil film FF is attached to the housing body 21, the transfer unit 50 transfers the foil transfer layer FF3 onto the printed layer T of the sheet S.

When the viscoelastic layer film PF is attached to the housing body 21, the transfer unit 50 transfers the viscoelastic layer PF3 onto the printed layer T of the sheet S.

The transfer unit 50 includes a pressure roller 51 as an example of a pressure rotating member, a heating roller 60 as an example of a heating rotating member, a frame 61, and an actuator 70.

The pressure roller 51 is a roller that sandwiches the film F and the sheet S between the pressure roller 51 and the heating roller 60, and is made of a cylindrical core metal whose periphery is covered with a rubber layer made of silicone rubber. The pressure roller 51 is disposed above the film F and is configured to come into contact with a surface of the sheet S opposite to a surface on which the printed layer T is formed. The pressure roller 51 is rotatably supported at both ends by the cover 22. The pressure roller 51 conveys the film F and the sheet S between the pressure roller 51 and the heating roller 60 in a state of being in pressure contact with the heating roller 60.

The heating roller 60 is a roller that heats the film F and the sheet S. The heating roller 60 is disposed below the film F and is configured to come into contact with the film F.

The frame 61 rotatably supports the heating roller 60. The frame 61 is configured to cover the heating roller 60 so as to make it difficult for heat from the heating roller 60 to be released. As shown in FIG. 6A, the frame 61 has a frame opening 62. The frame opening 62 is formed at a position where heat generated by the heating roller 60 reaches the peeling position.

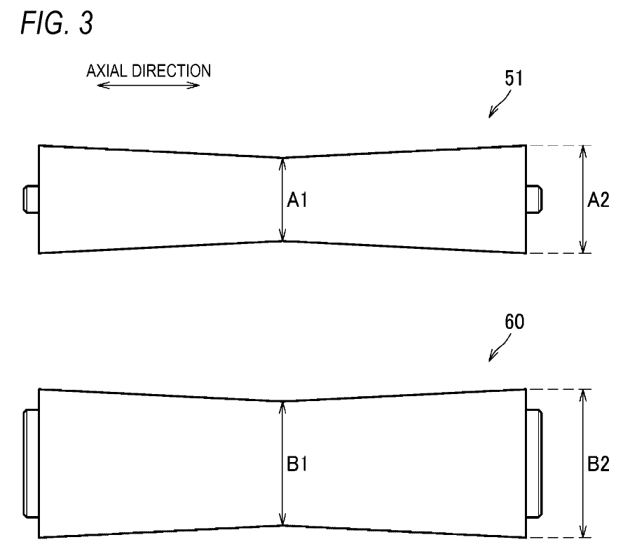

As shown in FIG. 3, the pressure roller 51 and the heating roller 60 are formed in an inverted crown shape, and are both formed such that the diameter increases from a central portion toward end portions in the axial direction. Specifically, a diameter A1 of the central portion of the pressure roller 51 in the axial direction is smaller than a diameter A2 of the end portion in the axial direction (A1 < A2). Further, a diameter B1 of the central portion of the heating roller 60 in the axial direction is smaller than a diameter B2 of the end portion in the axial direction (B1 < B2).

The actuator 70 is a member that moves the heating roller 60 between a pressure contact position (indicated by a solid line in FIG. 1A) where the heating roller 60 and the pressure roller 51 are in pressure contact with each other and a separation position (indicated by a two-dot chain line in FIG. 1A) where the heating roller 60 and the pressure roller 51 are separated from each other.

The pressure roller 51 and the heating roller 60 can convey the film F and the sheet S by being driven in a pressure contact state. Specifically, the pressure roller 51 is driven to rotate in a state where the heating roller 60 is positioned at the pressure contact position, thereby rotating the heating roller 60. Thus, the pressure roller 51 and the heating roller 60 convey the film F and the sheet S being sandwiched between the pressure roller 51 and the heating roller 60.

In the layer transfer device 1 configured as described above, the sheet S set on the sheet tray 3 with the surface on which the printed layer T is formed facing downward is conveyed one by one toward the transfer unit 50 by the sheet supply mechanism 11. The sheet S is overlaid on the film F supplied from the supply reel 31 on an upstream side of the transfer unit 50 in a sheet conveying direction, and is conveyed to the transfer unit 50 in a state where the printed layer T of the sheet S and the film F are in contact with each other.

In the transfer unit 50, when the sheet S and the film F pass through a nip portion between the pressure roller 51 and the heating roller 60, they are heated and pressed by the heating roller 60 and the pressure roller 51, and a layer (the viscoelastic layer PF3 or the foil transfer layer FF3) is transferred onto the printed layer T formed on the sheet S. In the following description, transfer of a layer to the sheet S is also simply referred to as "layer transfer".

After the layer transfer is performed, the sheet S and the film F are conveyed to the second guide shaft 42 in a tightly contact state. When the sheet S and the film F pass through the second guide shaft 42, the conveying direction of the film F is changed to a direction different from the conveying direction of the sheet S, so that the film F is peeled off from the sheet S.

The film F peeled off from the sheet S is taken up by the take-up reel 35. On the other hand, the sheet S from which the film F is peeled off is discharged to the outside of the housing 2 by the sheet discharge mechanism 12 in a state where a surface to which the layer is transferred faces downward.

The electrical contact CN is the part that comes into contact with the memory 31M when the film cartridge FC is attached to the housing body 21. When the supply reel 31 is attached to the housing body 21, the electrical contact CN comes into contact with the memory 31M, and information in the memory 31M is transmitted to the controller 300.

The controller 300 includes a CPU, a RAM, a ROM, an input and output circuit, and the like, and executes control by performing various types of arithmetic processing based on programs and data stored in the ROM or the like.

Here, the control executed by the controller 300 will be described.

The controller 300 can execute a foil save mode (hereinafter referred to as an "FS mode"). The FS mode is a mode in which, in order to conserve the film F, the heating roller 60 is separated while a region of the sheet S on which the printed layer T is not formed passes through the transfer unit 50, and the heating roller 60 is pressed against the sheet S only while a region of the sheet S on which the printed layer T is formed passes through the transfer unit 50. That is, in the FS mode, when transferring a layer to the printed layer T formed on the sheet S, the controller 300 controls the actuator 70 such that the heating roller 60 is positioned at the separation position at a timing when the region where the printed layer T is not formed passes through the transfer position, and the heating roller 60 is positioned at the pressure contact position at a timing when the region where the printed layer T is formed reaches the transfer position. The user can select whether to enable the FS mode.

Specifically, as illustrated in FIG. 5A, in a case where the downstream side in the conveying direction of the sheet S is a blank region BA and an image forming region TA is formed only on the upstream side, the controller 300 keeps the heating roller 60 separated until halfway through the blank region BA, and then presses the heating roller 60 from halfway through the blank region BA until a while after the image forming region TA has passed.

Further, as illustrated in FIG. 5B, in a case where a downstream portion and an upstream portion in the conveying direction of the sheet S are blank regions BA and the image forming region TA is formed only at the center, the controller 300 keeps the heating roller 60 in pressure contact with the sheet S only from a little before the image forming region TA until a while after the image forming region TA has passed.

As illustrated in FIG. 5C, in a case where the upstream side in the conveying direction of the sheet S is the blank region BA and the image forming region TA is formed only on the downstream side, the controller 300 keeps the heating roller 60 in pressure contact with the sheet S until a certain period of time has elapsed since a leading edge of the sheet and the image forming region TA has passed, and then causes the heating roller 60 to be separated.

Further, the controller 300 determines whether the first supply reel 31P or the second supply reel 31F is attached to the housing body 21 by reading the information of the memory 31M. In the present embodiment, the controller 300 controls the temperature of the film F at the peeling position by controlling the temperature of the heating roller 60. Specifically, the controller 300 can increase the temperature of the peeling position by increasing the temperature of the heating roller 60, and can decrease the temperature of the peeling position by decreasing the temperature of the heating roller 60.

When it is determined that the first supply reel 31P is attached to the housing body 21, the controller 300 controls the viscoelastic layer film PF to reach the first temperature T1 at the peeling position where the first base layer PF1 is to be peeled off from the viscoelastic layer PF3.

When the second supply reel 31F is attached to the housing body 21, the controller 300 controls the foil film FF to reach a second temperature T2 different from the first temperature T1 at the peeling position where the foil base layer FF1 is peeled off from the foil film FF. The second temperature T2 is a temperature different from the first temperature T1. In the present embodiment, the second temperature T2 is a temperature lower than the first temperature T1 (T2 < T1).

Next, a procedure for transferring the foil will be described with reference to FIGS. 7A to 7C.

As illustrated in FIG. 7A, when transferring the foil to the sheet S, first, the printed layer T is printed on the sheet S using an image forming device.

Next, the sheet S on which the printed layer T is printed is set on the sheet tray 3 of the layer transfer device 1. After the sheet S is set on the sheet tray 3, it is sent to the transfer unit 50, where the sheet S and the foil film FF are thermally and pressure-bonded together an overlapping state, as illustrated in FIG. 7B. When the sheet S and the foil film FF are thermally and pressure-bonded together in an overlapping state, the foil transfer layer FF3 is pressure-bonded to a portion where the printed layer T is formed, and the foil transfer layer FF3 is not pressure-bonded to a portion where the printed layer T is not formed. As a result, as shown in FIG. 7C, the foil transfer layer FF3 is pressure-bonded only to the portion where the printed layer T is formed, and the foil transfer layer FF3 that is not pressure-bonded to the printed layer T remains on the foil film FF. In this manner, the foil transfer layer FF3 is transferred to the printed layer T by the layer transfer device 1. At this time, the foil base layer FF1 is automatically peeled off by the layer transfer device 1 and wound around the take-up reel 35.

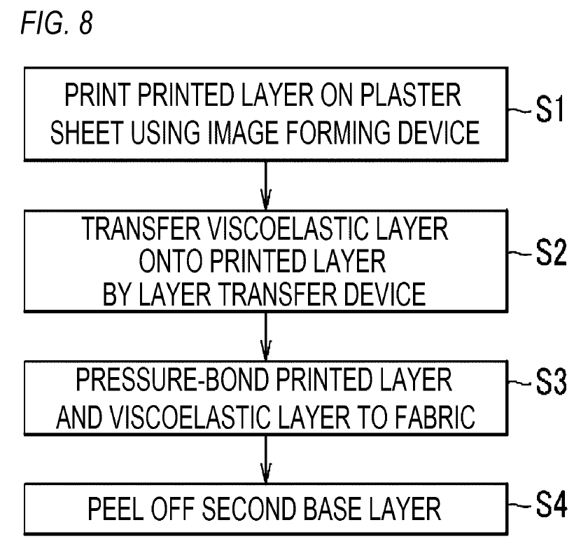

Next, a procedure of transferring the printed layer T to the fabric CL using the transfer printing sheet PS will be described with reference to FIGS. 8, 9A to 9C, and 11A to 11B.

As illustrated in FIGS. 8 and 9A to 9C, when transferring the printed layer T to the fabric CL, first, the printed layer T is printed on the transfer printing sheet PS, which is a material for forming the printed layer in an image forming device (S1).

Next, the transfer printing sheet PS on which the printed layer T is printed is set on the sheet tray 3 of the layer transfer device 1. Then, when the transfer printing sheet PS is sent to the transfer unit 50, as shown in FIG. 9B, the transfer printing sheet PS and the viscoelastic layer film PF are thermally and pressure-bonded in an overlapping state in the transfer unit 50. When the transfer printing sheet PS and the viscoelastic layer film PF are thermally and pressure-bonded in an overlapping state, the viscoelastic layer PF3 is pressure-bonded to the portion where the printed layer T is formed. The viscoelastic layer PF3 is not pressure-bonded to a portion where the printed layer T is not formed.

When the portion where the printed layer T is formed moves to the peeling position, the transfer printing sheet PS continues to travel along a conveying path of the sheet S, and the viscoelastic layer film PF is guided by the second guide shaft 42 to change the traveling direction and is guided downward (see FIG. 1A). Then, as shown in FIG. 9C, since the first peeling force H1 of the first release layer PF2, which is a force required to peel off the first base layer PF1 from the viscoelastic layer PF3, is smaller than the second peeling force H2 of the second release layer PS2, which is a force required to peel off the second base layer PS1 from the printed layer T (H1 < H2), the printed layer T and the viscoelastic layer PF3 remain on the transfer printing sheet PS, and the viscoelastic layer PF3 corresponding to the portion where the printed layer T is not formed remains on the viscoelastic layer film PF. In this way, the viscoelastic layer PF3 is transferred to the printed layer T of the transfer printing sheet PS (S2).

At this time, the first base layer PF1 of the viscoelastic layer film PF is automatically peeled off by the layer transfer device 1 without being manually peeled off by the user. Since the controller 300 controls the viscoelastic layer film PF to be at the first temperature T1 at the peeling position, the first base layer PF1 is peeled off from the viscoelastic layer PF3 at the first temperature T1 at the peeling position.

Next, as shown in FIG. 11A, in a state where the viscoelastic layer PF3 is transferred to the printed layer T of the transfer printing sheet PS, the transfer printing sheet PS is overlaid on the fabric CL and heated and pressed together using a dedicated pressing machine (not shown). Then, the printed layer T and the viscoelastic layer PF3 are pressure-bonded to the fabric CL (S3).

After the printed layer T and the viscoelastic layer PF3 are pressure-bonded to the fabric CL, the user peels off the second base layer PS1 of the transfer printing sheet PS (S4). As shown in FIG. 11B, when the second base layer PS1 of the transfer printing sheet PS is peeled off, only the printed layer T and the viscoelastic layer PF3 remain on the fabric CL.

According to the layer transfer device 1, the following effects can be obtained.

According to the layer transfer device 1, the transfer unit 50 overlays the transfer printing sheet PS on which the printed layer T is formed on the viscoelastic layer film PF supplied from the first supply reel 31P and heats them with the heating roller 60, so that the viscoelastic layer PF3 of the viscoelastic layer film PF can be transferred to the printed layer T of the transfer printing sheet PS. After the layer transfer device 1 attaches the viscoelastic layer PF3 to the printed layer T, the first base layer PF1 of the viscoelastic layer film PF, from which the viscoelastic layer PF3 has been transferred, is taken up by the take-up reel 35. Therefore, when transferring the viscoelastic layer PF3 to the printed layer T of the transfer printing sheet PS, the user does not have to manually peel off the first base layer PF1 that has supported the viscoelastic layer PF3.

In a layer transfer device in the related art, since a user manually peels off a first base layer from a viscoelastic layer, it is difficult to maintain a constant peeling angle. However, in the layer transfer device 1, since the first base layer PF1 is automatically peeled without manual work, it is easy to keep the peeling angle constant, and it is possible to reduce peeling failure.

Since the viscoelastic layer film PF is wound around the first supply reel 31P so that the viscoelastic layer PF3 faces the winding core 31A of the first supply reel 31P, the viscoelastic layer PF3 is covered and protected by the first base layer PF1 in a state where the viscoelastic layer film PF is wound around the first supply reel 31P.

Further, as shown in FIG. 9C, the first peeling force H1 of the first release layer PF2 is smaller than the second peeling force H2 of the second release layer PS2, so that the first base layer PF1 and the first release layer PF2 are peeled off from the viscoelastic layer PF3 in a state where the printed layer T and the viscoelastic layer PF3 are held by the second release layer PS2.

Further, the controller 300 controls the viscoelastic layer film PF to be at the first temperature T1 at the peeling position when the first supply reel 31P is mounted, and controls the foil film FF to be at the second temperature T2 at the peeling position when the second supply reel 31F is mounted. Therefore, in both cases of transferring the viscoelastic layer PF3 and transferring the foil, the base layer (the first base layer PF1, the foil base layer FF1) can be appropriately peeled off. Further, since the first base layer PF1 is peeled off from the viscoelastic layer PF3 at the first temperature T1 at the peeling position, the temperature at the time of peeling can be made constant, and the peeling failure can be prevented.

Further, the radius of curvature of the second guide shaft 42 is 1 mm to 3 mm, so that the first base layer PF1 is easier to peel off as compared with a case where the radius of curvature is larger than 3 mm.

Further, the wrapping angle of the film F around the second guide shaft 42 is an obtuse angle, so that the first base layer PF1 is easily peeled off.

Further, the controller 300 determines whether the first supply reel 31P or the second supply reel 31F is attached based on the information in the memory 31M, so that the user does not need to input an instruction to the layer transfer device 1 regarding the type of the supply reel 31.

Further, the layer transfer device 1 transfers the viscoelastic layer PF3 to the printed layer T using the viscoelastic layer film PF wound around the supply reel 31, and the controller 300 can execute the foil save mode (FS mode), so that it is possible to prevent the viscoelastic layer film PF from being used in a portion where the printed layer T is not formed. That is, it is possible to prevent the viscoelastic layer film PF from being wasted.

Further, as illustrated in FIG. 3, since the pressure roller 51 and the heating roller 60 each have an inverted crown shape, the conveyance speed is higher at both end portions than at the central portion in the axial direction. Therefore, when the sheet S and the film F are conveyed, the sheet S and the film F can be conveyed while being stretched from the central portion toward both end portions in the axial direction. As a result, the sheet S and the film F can be prevented from being wrinkled, and even if air bubbles are trapped between the sheet S and the film F, the air bubbles can be released to the outside in the axial direction.

Although the embodiment has been described above, the layer transfer device may be appropriately modified and implemented as exemplified below.

In the above-described present embodiment, the controller 300 controls the temperature of the film F at the peeling position by controlling the temperature of the heating roller 60, but the present disclosure is not limited thereto.

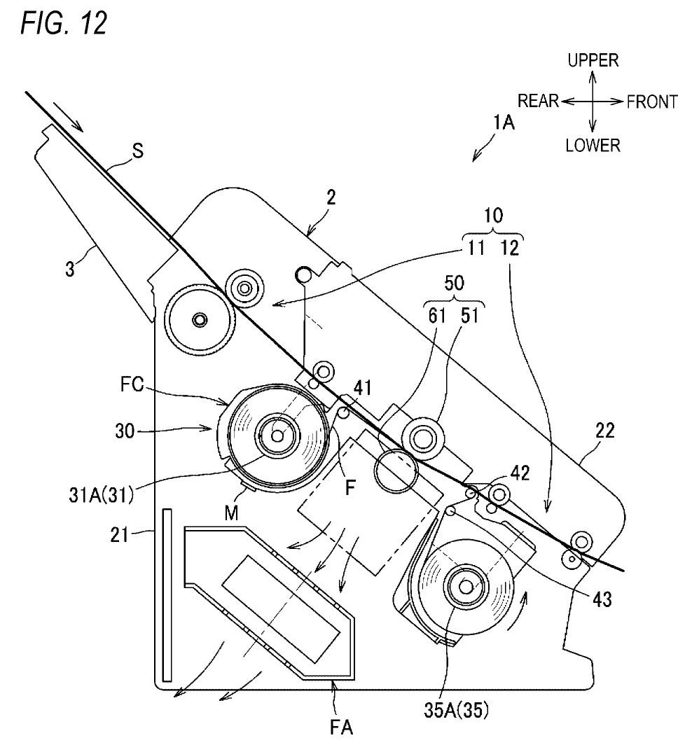

For example, a layer transfer device 1A illustrated in FIG. 12 further includes a fan FA that exhausts air from inside the housing body 21 to the outside of the housing body 21. The controller 300 may control the temperature of the film F at the peeling position by driving or stopping the fan FA.

Although not illustrated, the controller 300 may control the temperature of the film F at the peeling position by opening and closing the frame opening 62 of the frame 61 illustrated in FIG. 6A.

Further, in the above-described embodiment, the memory 31M is disposed in the supply reel 31. Alternatively, the memory 31M may be disposed in the take-up reel 35 or may be disposed in a coupling portion that couples the supply reel 31 and the take-up reel 35. Further, in the case of a configuration in which the memory storing information on the film F is not provided, the user may input information on the type of the film F to be used.

Further, in the above-described embodiment, the second temperature T2 is a temperature lower than the first temperature T1 (T2 < T1). Alternatively, the second temperature T2 may be a temperature higher than the first temperature T1 (T1 < T2).

Further, in the above-described embodiment, the configuration in which the printed layer T such as a toner image is formed on the sheet S using an image forming device such as a laser printer is exemplified. Alternatively, the printed layer may be formed using other image forming devices such as an inkjet printer or screen printing.

Further, in the above-described embodiment, the heating roller 60 (heating rotating member) is movable between the pressure contact position where the heating roller 60 is in pressure contact with the pressure roller 51 (pressure rotating member) and the separation position where the heating roller 60 is separated from the pressure roller 51. For example, the pressure rotating member may be movable between a pressure contact position where it is in pressure contact with a heating rotating member and a separation position where it is separated from the heating rotating member. Further, each of the heating rotating member and the pressure rotating member may be movable between a pressure contact position where the heating rotating member and the pressure rotating member are in pressure contact with each other and a separation position where the heating rotating member and the pressure rotating member are separated from each other.

The elements described in the above embodiment and modifications may be implemented in any combination.

Next, a second embodiment will be described in detail with reference to the drawings as appropriate. Since the present embodiment is a partial modification of the structure of the first embodiment, the same components as those of the first embodiment are denoted by the same reference numerals, and the description thereof will be omitted.

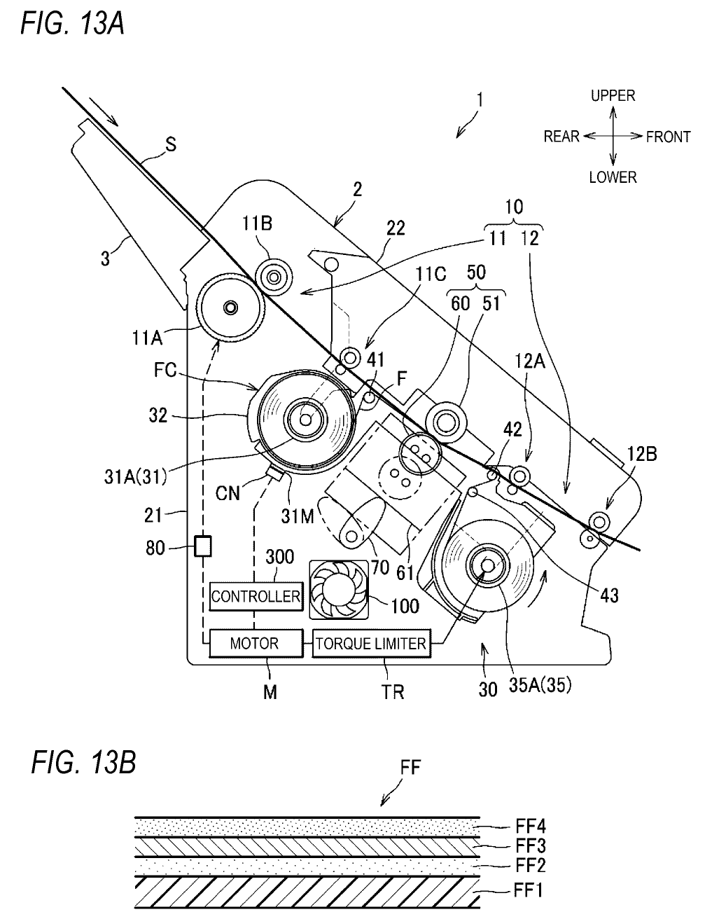

As illustrated in FIGS. 13A and 13B, the layer transfer device 1 according to the second embodiment includes a fan 100. The fan 100 is positioned inside the housing body 21. The fan 100 takes in air from the outside of the housing body 21 into the housing body 21 and exhausts the air from the inside of the housing body 21 to the outside of the housing body 21, thereby cooling the inside of the housing body 21.

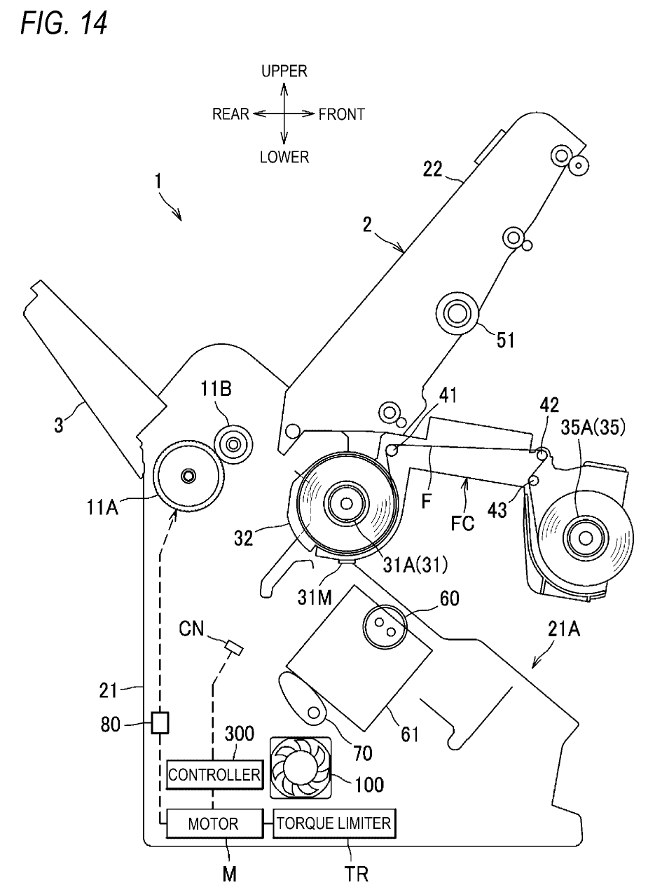

As shown in FIG. 14, the film cartridge FC is attachable to and detachable from the housing body 21 through the opening 21A in the direction orthogonal to the axial direction of the supply reel 31 to be described later. In the following description, the axial direction of the supply reel 31 is simply referred to as "axial direction". The film cartridge FC includes the supply reel 31, the take-up reel 35, the first guide shaft 41, the second guide shaft 42 as an example of a peeling member, and the third guide shaft 43. The film F is wound around the supply reel 31 of the film cartridge FC.

As illustrated in FIGS. 13A and 13B, the transfer unit 50 includes the pressure roller 51 as an example of the pressure rotating member, the heating roller 60 as an example of the heating rotating member, the frame 61, and the actuator 70 as an example of a switching mechanism.

The actuator 70 is a mechanism capable of switching a state of the heating roller 60 and the pressure roller 51 between a pressure state in which the film F is sandwiched between the heating roller 60 and the pressure roller 51, and a separated state in which the heating roller 60 is separated from the film F. The pressure roller 51 and the heating roller 60 can convey the film F and the sheet S by being rotationally driven in the pressure state. When the pressure roller 51 is rotated by the driving force of the motor M, the heating roller 60 is driven to rotate.

When the pressure roller 51 and the heating roller 60 are in the separated state, the take-up reel 35 does not rotate even if the motor M rotates. When the pressure roller 51 and the heating roller 60 are in the pressure state and rotate, the take-up reel 35 rotates, and the film F fed from the pressure roller 51 and the heating roller 60 is taken up by the take-up reel 35.

The electrical contact CN is the part that comes into contact with the memory 31M when the film cartridge FC is attached to the housing body 21. When the supply reel 31 is attached to the housing body 21, the electrical contact CN comes into contact with the memory 31M, and information in the memory 31M is transmitted to the controller 300.

The controller 300 includes a CPU, a RAM, a ROM, an input and output circuit, and the like, and executes control by performing various types of arithmetic processing based on programs and data stored in the ROM or the like. The controller 300 determines whether the first supply reel 31P or the second supply reel 31F is attached to the housing body 21 by reading the information of the memory 31M.

When it is determined that the first supply reel 31P is mounted, the controller 300 can execute a viscoelastic layer transfer process suitable for transferring the viscoelastic layer PF3 to the printed layer T of the sheet S. When it is determined that the second supply reel 31F is mounted, the controller 300 can execute a foil transfer process suitable for transferring the foil transfer layer FF3 to the printed layer T of the sheet S. Since the foil transfer processing may be performed by a known method, the description thereof will be omitted.

The controller 300 stops the fan 100 while executing the viscoelastic layer transfer process. In the viscoelastic layer transfer process, the controller 300 can execute a conveying process, a switching process, and a peeling process.

In the conveying process, the controller 300 controls a supply roller 11A and an upstream conveying roller 11C to convey the sheet S toward the heating roller 60 and the pressure roller 51, which are in the separated state.

Here, the motor M is connected to the supply roller 11A via a supply clutch 80. The motor M is connected to the pressure roller 51, the upstream conveying roller 11C, a downstream conveying roller 12A, and a discharge roller 12B. A clutch may be appropriately provided between the motor M and each of the rollers (51, 11C, 12A, and 12B).

The controller 300 rotates the motor M to rotate the pressure roller 51, the upstream conveying roller 11C, the downstream conveying roller 12A, and the discharge roller 12B. The controller 300 turns on the supply clutch 80 while the motor M is rotating, thereby rotating the supply roller 11A.

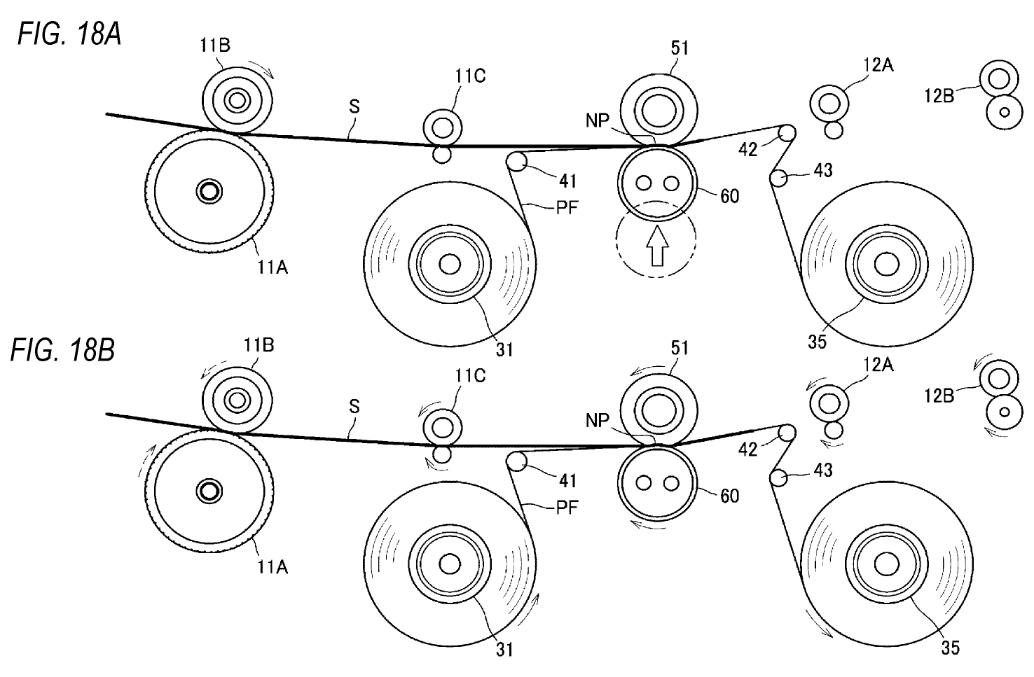

In the switching process, the controller 300 controls the actuator 70 to switch the heating roller 60 and the pressure roller 51 from the separated state to the pressure state. At the time when the heating roller 60 and the pressure roller 51 are brought into the pressure state by the switching process, a leading end of the sheet S is positioned on the downstream side of a nip portion NP (see FIGS. 18A and 18B) between the heating roller 60 and the pressure roller 51 in the conveying direction, and a trailing end of the sheet S is positioned on the upstream side of the nip portion NP in the conveying direction. That is, the controller 300 executes the switching process such that a portion of the sheet S slightly separated from the leading end is sandwiched between the heating roller 60 and the pressure roller 51.

Here, the nip portion NP refers to a portion of the pressure roller 51 or the heating roller 60 that comes into contact with the viscoelastic layer film PF in the pressure state. Further, the size of a leading end portion of the sheet S in the conveying direction that is not sandwiched between the heating roller 60 and the pressure roller 51 may be, for example, smaller or larger than the size of the nip portion NP in the conveying direction.

The controller 300 continues to drive the supply roller 11A and the upstream conveying roller 11C until the sheet S reaches between the heating roller 60 and the pressure roller 51. Specifically, the controller 300 continues to rotate the motor M and keeps the supply clutch 80 on until a portion slightly separated from the leading end reaches between the heating roller 60 and the pressure roller 51.

In the peeling process, the controller 300 keeps the heating roller 60 and the pressure roller 51 in the pressure state and rotates the heating roller 60 and the pressure roller 51 until the trailing end of the sheet S being conveyed by the downstream conveying roller 12A passes through the second guide shaft 42, and after the trailing end of the sheet S passes through the second guide shaft 42, switches the heating roller 60 and the pressure roller 51 from the pressure state to the separated state. When the viscoelastic layer transfer process is performed on a plurality of sheets S consecutively, the controller 300 executes the peeling process on each sheet S.

In the present embodiment, a sheet sensor that detects the sheet S set on the sheet tray 3 is provided near the sheet tray 3. The controller 300 executes the viscoelastic layer transfer process for each sheet S on the condition that the sheet sensor detects the sheet S and a layer transfer command is received. The layer transfer command is output to the controller 300, for example, when a user operates an operation panel provided on an outer surface of the layer transfer device 1.

When the controller 300 receives the layer transfer command in a state where only one sheet S is set on the sheet tray 3, the controller 300 executes the viscoelastic layer transfer process on the one sheet S. When the controller 300 receives the layer transfer command in a state where a plurality of sheets S are set on the sheet tray 3, the controller 300 executes the viscoelastic layer transfer process on each of the plurality of sheets S in succession.

Next, the operation of the controller 300 will be described in detail. When the controller 300 does not execute the viscoelastic layer transfer process, the heating roller 60 and the pressure roller 51 are in the separated state. A process of energizing a heater of the heating roller 60 may be appropriately performed before the sheet S is sandwiched between the heating roller 60 and the pressure roller 51, and the description thereof will be omitted.

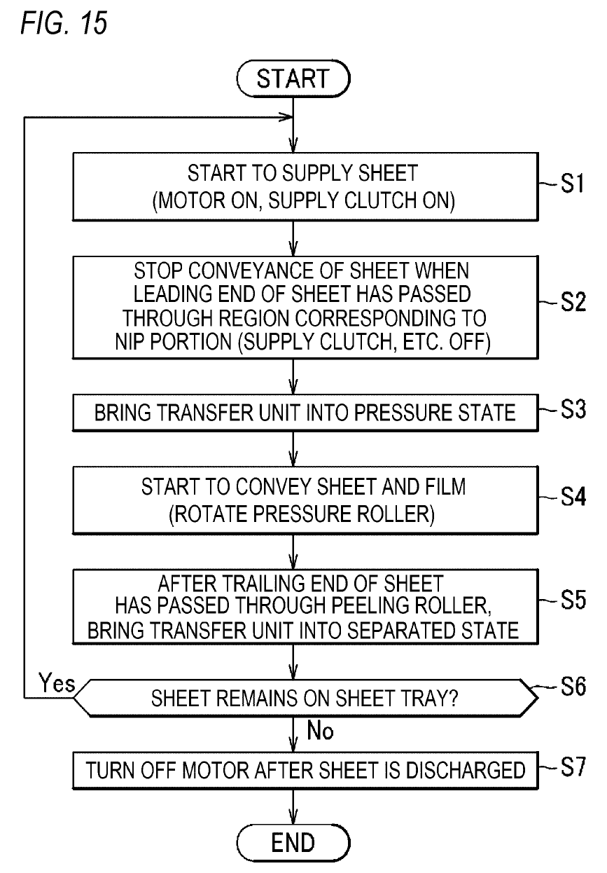

As shown in FIG. 15, when a layer transfer command is received (START), the controller 300 starts to supply the sheet S from the sheet tray 3 (S1). Specifically, in step S1, the controller 300 rotates the motor M and turns on the supply clutch 80, thereby rotating the supply roller 11A.

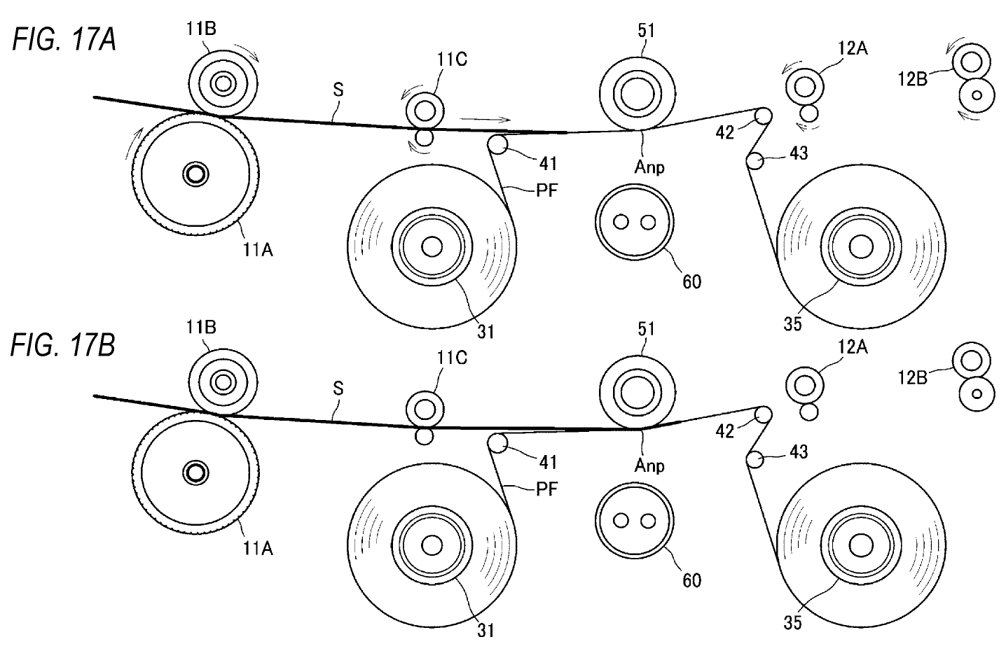

After step S1, the controller 300 stops the conveyance of the sheet S at a timing when the leading end of the sheet S has passed through a region Anp (see FIG. 17A) corresponding to the nip portion NP (S2). Specifically, in step S2, the controller 300 turns off the supply clutch 80 and stops the motor M to stop the conveyance of the sheet S (S2).

The timing when the leading end of the sheet S has passed through the region Anp corresponding to the nip portion NP can be grasped by, for example, an elapsed time from the start of rotation of the supply roller 11A. Further, in a case where a sheet passing sensor for detecting passage of the sheet S is provided between the supply roller 11A and the upstream conveying roller 11C, the timing can be grasped by an elapsed time after the passage of the leading end of the sheet S is detected by the sheet passage sensor.

After step S2, the controller 300 controls the actuator 70 to bring the transfer unit 50 (the heating roller 60 and the pressure roller 51) into the pressure state (S3). After step S3, the controller 300 restarts the rotation of the motor M to rotate the pressure roller 51 and the like, thereby starting the conveyance of the sheet S and the viscoelastic layer film PF (S4).

After step S4, the controller 300 determines whether the trailing end of the sheet S has passed through the second guide shaft 42, and if it is determined that the trailing end of the sheet S has passed through the second guide shaft 42, the controller 300 brings the transfer unit 50 into the separated state (S5). Whether the trailing end of the sheet S has passed through the second guide shaft 42 can be determined based on the time elapsed since the start of rotation of the supply roller 11A as described above.

After step S5, the controller 300 determines whether the sheet S remains on the sheet tray 3 based on information from the sheet sensor (S6). When it is determined in step S6 that the sheet S remains (Yes), the controller 300 returns to the process of step S1.

When it is determined in step S6 that no sheets S remains (No), the controller 300 stops the motor M (S7) after the sheet S is discharged to the outside of the housing 2, and ends the process. Whether the sheet S is discharged to the outside of the housing 2 can be determined based on the time elapsed since the start of the rotation of the supply roller 11A as described above.

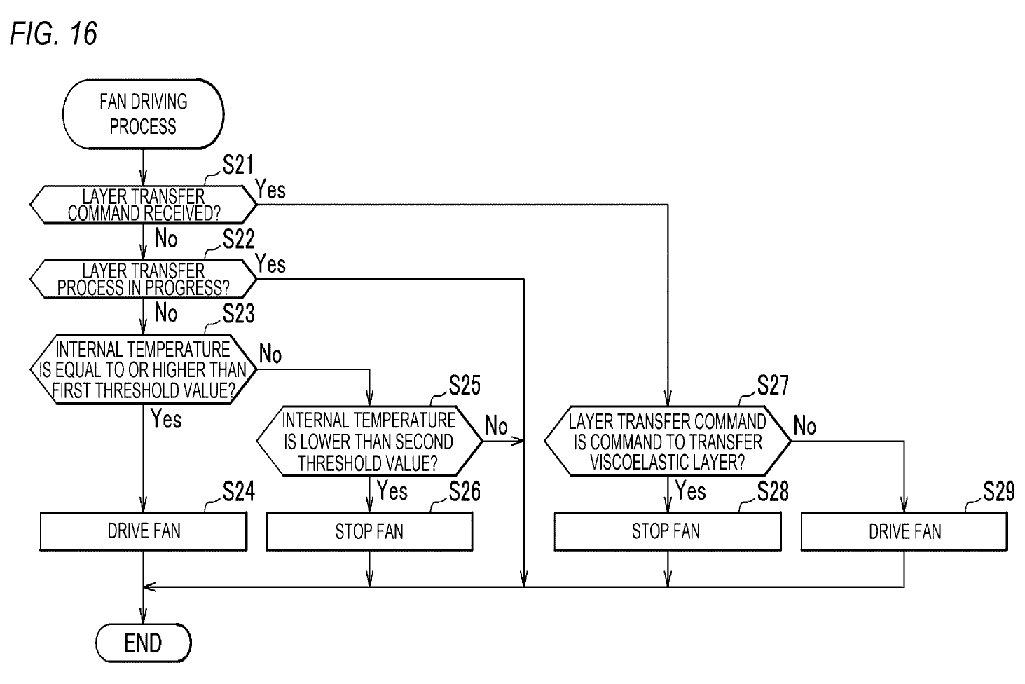

The controller 300 constantly executes a fan driving process shown in FIG. 16.

In the fan driving process, first, the controller 300 determines whether a layer transfer command has been received (S21). If it is determined in step S21 that the layer transfer command has not been received (No), the controller 300 determines whether a layer transfer process is currently being performed (S22).

If it is determined in step S22 that the layer transfer process is not being performed (No), the controller 300 determines whether a temperature inside the housing 2 (hereinafter, also referred to as "internal temperature") is equal to or higher than a first threshold value (S23). Here, the internal temperature may be detected by a temperature sensor positioned in the housing 2.

If it is determined in step S23 that the internal temperature is equal to or higher than the first threshold value (Yes), the controller 300 drives the fan 100 (S24) and ends the process. If it is determined in step S23 that the internal temperature is not equal to or higher than the first threshold value (No), the controller 300 determines whether the internal temperature is lower than a second threshold value (S25).

Here, the second threshold value may be, for example, a value smaller than the first threshold value. The second threshold value may be the same value as the first threshold value.

If it is determined in step S25 that the internal temperature is lower than the second threshold value (Yes), the controller 300 stops the fan 100 (S26) and ends the process. If it is determined in step S25 that the internal temperature is not lower than the second threshold value (No), the controller 300 ends the present process.

If it is determined in step S21 that the layer transfer command has been received (Yes), the controller 300 determines whether the layer transfer command is a command to transfer the viscoelastic layer PF3 (S27). In the present embodiment, in step S27, the controller 300 determines whether the received layer transfer command is a command to transfer the viscoelastic layer PF3 by determining whether the first supply reel 31P around which the viscoelastic layer film PF is wound is mounted on the housing 2.

If it is determined in step S27 that the command is to transfer the viscoelastic layer PF3 (Yes), the controller 300 stops the fan 100 (S28) and ends the process. If it is determined in step S27 that the command is not to transfer the viscoelastic layer PF3 (No), the controller 300 drives the fan 100 (S29) and ends the process. That is, the controller 300 stops the fan 100 when transferring the viscoelastic layer PF3, and drives the fan 100 when foil transfer is performed.

Next, the operation and effect when the viscoelastic layer transfer process is executed will be described.

As illustrated in FIG. 17A, when the controller 300 receives a layer transfer command to execute the viscoelastic layer transfer process, the controller 300 rotates the supply roller 11A and the upstream conveying roller 11C to convey the sheet S toward between the pressure roller 51 and the heating roller 60, which are in the separated state. The controller 300 continues to rotate the supply roller 11A and the upstream conveying roller 11C until a portion slightly separated from the leading end of the sheet S reaches between the pressure roller 51 and the heating roller 60.

Here, in a configuration provided with the supply reel 31 and the take-up reel 35, the sheet S traveling from the upstream conveying roller 11C toward between the pressure roller 51 and the heating roller 60 encounters resistance by coming into contact with the viscoelastic layer PF3 of the viscoelastic layer film PF in a stationary state. At this time, if the supply clutch 80 is disengaged to stop the supply roller 11A, the supply roller 11A also acts as a resistance to the movement of the sheet S. Therefore, in the present embodiment, by continuing to drive the supply roller 11A and the upstream conveying roller 11C until the sheet S reaches between the pressure roller 51 and the heating roller 60, it is possible to prevent the supply roller 11A from acting as a resistance to the movement of the sheet S. Accordingly, even if the sheet S comes into contact with the viscoelastic layer PF3 of the viscoelastic layer film PF, the sheet S can be conveyed by the supply roller 11A and the upstream conveying roller 11C without being affected by the resistance of the viscoelastic layer PF3 of the viscoelastic layer film PF.

As illustrated in FIG. 17B, when the leading end of the sheet S passes through the region Anp corresponding to the nip portion NP, the controller 300 stops the supply roller 11A and the upstream conveying roller 11C. Thereafter, as illustrated in FIG. 18A, the controller 300 switches the pressure roller 51 and the heating roller 60 to the pressure state.

In this way, by switching the pressure roller 51 and the heating roller 60 to the pressure state in a state in which the leading end of the sheet S is positioned downstream of the region Anp corresponding to the nip portion NP in the conveying direction, the leading end of the sheet S is not sandwiched between the pressure roller 51 and the heating roller 60, and thus it is possible to prevent the leading end of the sheet S from being adhered to the viscoelastic layer film PF.

Thereafter, as illustrated in FIG. 18B, the controller 300 restarts driving the motor M to rotate the pressure roller 51 and the heating roller 60. Thus, the sheet S and the viscoelastic layer film PF are conveyed by the pressure roller 51 and the heating roller 60.

When the sheet S conveyed by the pressure roller 51 and the heating roller 60 reaches the second guide shaft 42, the sheet S is peeled off from the viscoelastic layer film PF by the second guide shaft 42 and directed toward the downstream conveying roller 12A. When the sheet S reaches the downstream conveying roller 12A, the sheet S is conveyed by the downstream conveying roller 12A and the pressure roller 51.

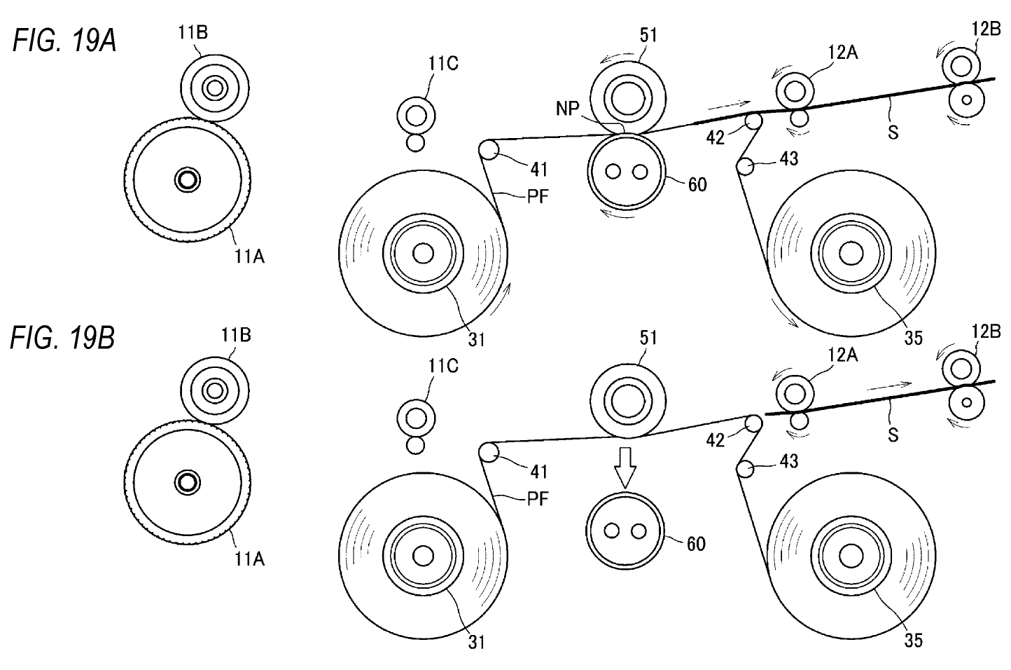

Thereafter, as illustrated in FIG. 19A, even after the trailing end of the sheet S passes through the nip portion NP, the controller 300 maintains the heating roller 60 and the pressure roller 51 in the pressure state and rotates the heating roller 60 and the pressure roller 51. As a result, the trailing end of the sheet S is sent to the downstream side in the conveying direction while being supported by the viscoelastic layer film PF conveyed by the pressure roller 51 and the heating roller 60. Here, for example, if the heating roller 60 and the pressure roller 51 are in the separated state after the trailing end of the sheet S has passed through the nip portion NP, the viscoelastic layer film PF stops, and thus the sheet S cannot be pulled by the downstream conveying roller 12A, which may result in a conveying failure. In this regard, in the present embodiment, even after the trailing end of the sheet S has passed through the nip portion NP, the state of the heating roller 60 and the pressure roller 51 is maintained in the pressure state and the heating roller 60 and the pressure roller 51 are rotated, so that a conveying force is applied to the sheet S from the viscoelastic layer film PF moving from the nip portion NP toward the take-up reel 35, and thus it is possible to prevent the conveying failure.

Then, as illustrated in FIG. 19B, the controller 300 separates the heating roller 60 from the pressure roller 51 immediately after the trailing end of the sheet S has passed through the second guide shaft 42. Accordingly, a conveying force is applied to the sheet S from the moving viscoelastic layer film PF until just before the trailing end of the sheet S passes through the second guide shaft 42, thereby making it possible to prevent the conveyance failure.

After the heating roller 60 is separated from the pressure roller 51, the pressure roller 51 may be kept rotating. When a clutch is provided between the motor M and the pressure roller 51, the pressure roller 51 may be stopped before or after the heating roller 60 is separated from the pressure roller 51.

From the above, the following effects can be achieved according to the present embodiment.

By adopting a configuration in which the leading end of the sheet S is positioned on the downstream side of the nip portion NP in the conveying direction and the trailing end of the sheet S is positioned on the upstream side of the nip portion NP in the conveying direction at the time when the heating roller 60 and the pressure roller 51 are in the pressure state, the leading end of the sheet S is not bonded to the viscoelastic layer film PF, and thus the viscoelastic layer film PF can be more reliably peeled off from the sheet S.

By keeping the heating roller 60 and the pressure roller 51 in the pressure state and rotating the heating roller 60 and the pressure roller 51 until the trailing end of the sheet S being conveyed by the downstream conveying roller 12A passes through the second guide shaft 42, the sheet S and the viscoelastic layer film PF can be conveyed by the heating roller 60 and the pressure roller 51 until the peeling of a portion near the trailing end of the sheet S is completed, so that the viscoelastic layer film PF can be peeled from the sheet S more reliably.

By adopting a configuration in which the driving of the supply roller 11A and the upstream conveying roller 11C is continued until the sheet S reaches between the heating roller 60 and the pressure roller 51, the supply roller 11A can be prevented from acting as a resistance to the movement of the sheet S, and therefore, even if the sheet S comes into contact with the viscoelastic layer PF3 of the viscoelastic layer film PF, it is possible to convey the sheet S by the supply roller 11A and the upstream conveying roller 11C without being affected by the resistance of the viscoelastic layer PF3 of the viscoelastic layer film PF.

By adopting a configuration in which the fan 100 is stopped while the layer transfer process of the viscoelastic layer PF3 is being performed, it is possible to prevent a transfer failure caused by the excessively low temperature of the viscoelastic layer PF3.

Next, a third of the present disclosure will be described in detail with reference to the drawings as appropriate. Since the present embodiment is a partial modification of the structure of the first embodiment, the same components as those of the first embodiment are denoted by the same reference numerals, and the description thereof will be omitted.

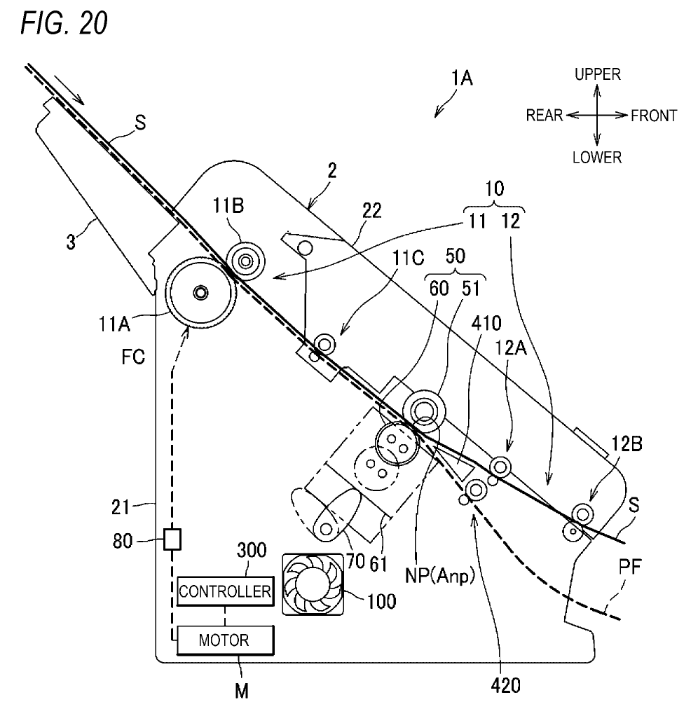

As illustrated in FIG. 20, a layer transfer device 1A according to the third embodiment is a device that conveys a sheet-shaped viscoelastic layer film PF and a sheet S in an overlapping state, transfers a viscoelastic layer PF3 to the sheet S, peels off the viscoelastic layer film PF from the sheet S, and discharges the sheet S and the viscoelastic layer film PF to the outside of the housing 2. The layer transfer device 1A is different from the first embodiment in that the film cartridge FC is not provided, and other structures are the same as those of the first embodiment. The width and length of the viscoelastic layer film PF may be, for example, to the same size as the width and length of the sheet S.

The layer transfer device 1A is different from the first embodiment in that a peeling claw 410 as an example of a peeling member and a second downstream conveying roller 420 are provided.

The peeling claw 410 is positioned on the downstream side of the nip portion NP in the conveying direction. The peeling claw 410 is disposed with a sharp tip end portion pointing toward the nip portion. The tip end portion of the peeling claw 410 is positioned in the vicinity of the nip portion NP.

The sheet S and the viscoelastic layer film PF conveyed in an overlapping state are peeled and separated into two pieces by the tip end portion of the peeling claw 410. After being peeled off from the viscoelastic layer film PF, the sheet S passes over the peeling claw 410 and heads toward the downstream conveying roller 12A. After being peeled off from the sheet S, the viscoelastic layer film PF passes under the peeling claw 410 and heads toward the second downstream conveying roller 420.

The second downstream conveying roller 420 is a roller for discharging the viscoelastic layer film PF to the outside of the housing 2. The second downstream conveying roller 420 is positioned on the downstream side of the peeling claw 410 in a conveying direction of the viscoelastic layer film PF (hereinafter also referred to as "second conveying direction"). The motor M is connected to the second downstream conveying roller 420.

The controller 300 according to the third embodiment performs the same control as that shown in FIG. 15 of the second embodiment. Specifically, in the control illustrated in FIG. 15, "second guide shaft 42" in step S5 may be replaced with "peeling claw 410".

Since the foil transfer is not performed in the layer transfer device 1A according to the third embodiment, the fan 100 may be controlled by removing step S27 and S29 from the process of FIG. 16. That is, when it is determined in step S21 that the layer transfer command has been received (Yes), the controller 300 may stop the fan 100 (S28) and end the present process.

Next, the operation and effect of executing the viscoelastic layer transfer process using the layer transfer device 1A will be described.

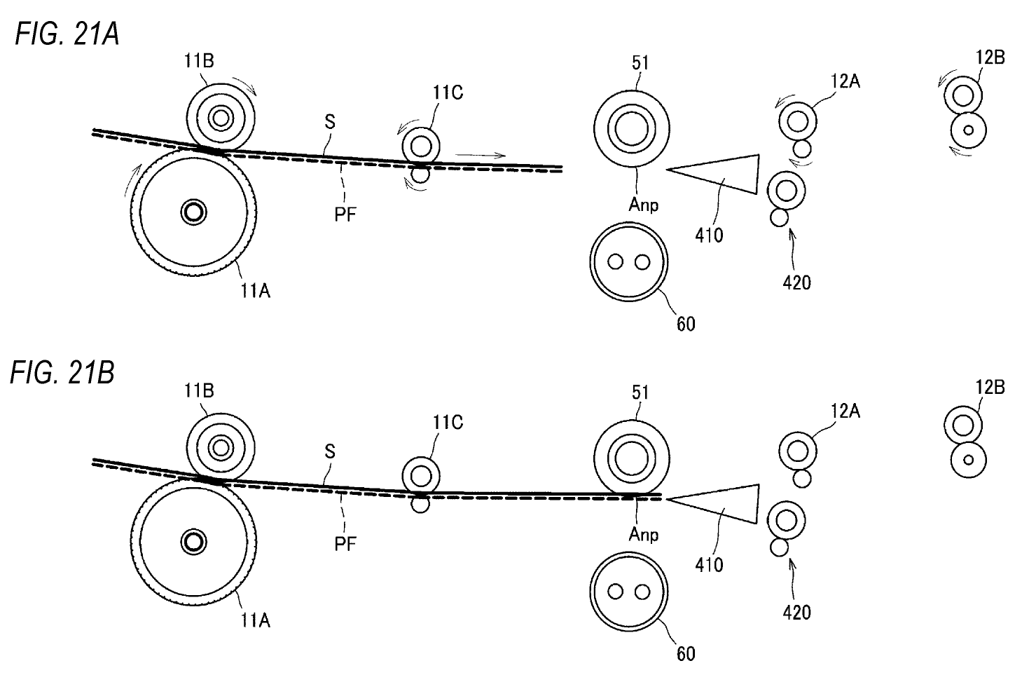

When the controller 300 receives a layer transfer command, as illustrated in FIG. 21A, the controller 300 rotates the supply roller 11A and the upstream conveying roller 11C to convey the sheet S and the viscoelastic layer film PF toward between the pressure roller 51 and the heating roller 60, which are in the separated state. The controller 300 continues to rotate the supply roller 11A and the upstream conveying roller 11C until a portion slightly separated from the leading end of the sheet S reaches between the pressure roller 51 and the heating roller 60.

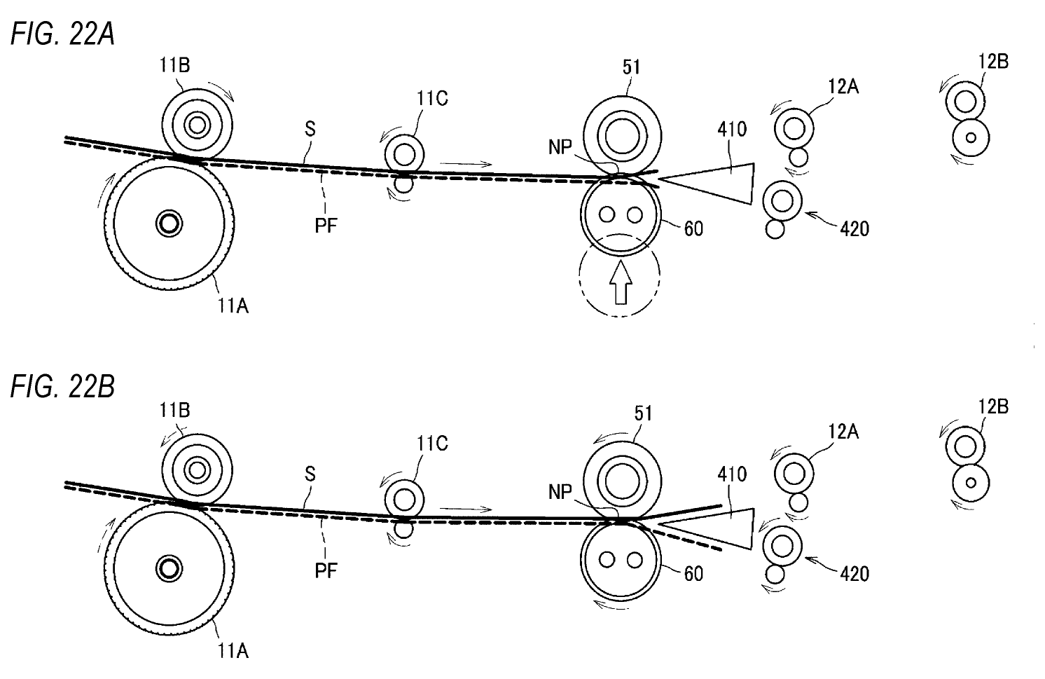

As illustrated in FIG. 21B, when the leading ends of the sheet S and the viscoelastic layer film PF pass through the region Anp corresponding to the nip portion NP, the controller 300 stops the supply roller 11A and the upstream conveying roller 11C. Thereafter, as illustrated in FIG. 22A, the controller 300 switches the pressure roller 51 and the heating roller 60 to the pressure state.

In this way, by switching the pressure roller 51 and the heating roller 60 to the pressure state in a state in which the leading end of the sheet S is positioned downstream of the region Anp corresponding to the nip portion NP in the conveying direction, the leading end of the sheet S is not sandwiched between the pressure roller 51 and the heating roller 60, and thus it is possible to prevent the leading end of the sheet S from being adhered to the leading end of the viscoelastic layer film PF. The leading end of the sheet S and the leading end of the viscoelastic layer film PF that are not adhered to each other are moved in directions away from each other by making the pressure roller 51 and the heating roller 60 to the pressure state.

Thereafter, as illustrated in FIG. 22B, the controller 300 restarts driving the motor M to rotate the pressure roller 51 and the heating roller 60. Thus, the sheet S and the viscoelastic layer film PF are conveyed by the pressure roller 51 and the heating roller 60.

When the tip end of the peeling claw 410 enters between the leading ends of the sheet S and the viscoelastic layer film PF being conveyed by the pressure roller 51 and the heating roller 60, the sheet S is peeled off from the viscoelastic layer film PF by the peeling claw 410 and directed toward the downstream conveying roller 12A, and the viscoelastic layer film PF is peeled off from the sheet S by the peeling claw 410 and directed toward the second downstream conveying roller 420.

When the sheet S reaches the downstream conveying roller 12A, the sheet S is conveyed by the downstream conveying roller 12A and the pressure roller 51. When the viscoelastic layer film PF reaches the second downstream conveying roller 420, the viscoelastic layer film PF is conveyed by the second downstream conveying roller 420 and the pressure roller 51.

According to the present specification, a layer transfer device according to the following aspects are provided.

The layer transfer device pressure-bonds the viscoelastic layer to the printed layer of the sheet, and then winds the base layer of the film around the take-up reel. Therefore, when transferring a viscoelastic layer to a printed layer of a sheet, it is possible to eliminate the effort required for a user to manually peel off a base layer that has been supporting the viscoelastic layer. In addition, the peeling angle can be easily kept constant, and peeling failure can be prevented.

Further, the film may be wound around the first supply reel such that the viscoelastic layer faces the winding core of the first supply reel.

The viscoelastic layer is wound so as to face the winding core of the first supply reel, so that the viscoelastic layer is covered and protected by the first base layer in a state where the film is wound around the first supply reel.

Further, the sheet further includes a second release layer between the second base layer and the printed layer, and at a first temperature which is a temperature at which the first base layer is peelable from the viscoelastic layer, a first peeling force of the first release layer, which is a force required to peel off the first base layer from the viscoelastic layer, may be smaller than a second peeling force of the second release layer, which is a force required to peel off the second base layer from the printed layer.

The first peeling force of the first release layer is smaller than the second peeling force of the second release layer, so that the first base layer and the first release layer are peeled off from the viscoelastic layer while the printed layer and the viscoelastic layer are held by the second release layer.

Further, a second supply reel, around which a foil film including a foil is wound, may be attached to the housing body of the layer transfer device instead of the first supply reel. The transfer unit may overlay a sheet on the foil film supplied from the second supply reel to transfer the foil to a printed layer formed on the sheet.

Further, the layer transfer device further includes a controller, and the controller may, when the first supply reel is attached to the housing body, control the film to be at the first temperature at a peeling position where the first base layer is to be peeled off from the viscoelastic layer, and when the second supply reel is attached to the housing body, control the foil film to be at a second temperature different from the first temperature at a peeling position where the base layer is to be peeled off from the foil film.

The controller controls the temperature of the film to be the first temperature at the peeling position when the first supply reel is attached, and controls the temperature of the foil film to be the second temperature different from the first temperature at the peeling position when the second supply reel is attached, so that the base layer can be appropriately peeled off in both cases of transferring the viscoelastic layer and the transferring foil. Further, since the first base layer is peeled off from the viscoelastic layer at the first temperature at the peeling position, the temperature at the time of peeling can be made constant, and the peeling failure can be prevented.

Further, the second temperature may be lower than the first temperature.

Further, the controller may control a temperature of the heating rotating member to control a temperature of the film at the peeling position to the first temperature and to control a temperature of the foil film at the peeling position to the second temperature.

Further, a fan configured to exhaust air in the housing body to an outside of the housing body is further provided, and the controller may drive or stop the fan to control a temperature of the film at the peeling position to the first temperature and to control a temperature of the foil film at the peeling position to the second temperature.

Further, a frame that covers the heating rotating member is further provided, and the frame may have a frame opening formed at a position where heat generated by the heating rotating member reaches the peeling position.

Further, a torque limiter configured to limit torque of a driving force supplied from the motor to the take-up reel is further provided, and the torque limiter may apply, to the take-up reel, torque of a magnitude large enough to peel off the first base layer from the viscoelastic layer.

Further, a peeling shaft configured to guide the first base layer of the film that has passed through the transfer unit in a direction different from a conveying direction of a sheet is further provided, and a radius of curvature of the peeling shaft at a portion where the film is wrapped may be 1 mm to 3 mm.

The radius of curvature of the peeling shaft is 1 mm to 3 mm, so that the first base layer is easier to peel off as compared with a case where the radius of curvature is larger than 3 mm.

A wrapping angle of the film around the peeling shaft may be an obtuse angle.

The wrapping angle of the film around the peeling shaft is an obtuse angle, so that the first base layer is easily peeled off.

Further, the first supply reel and the second supply reel may each include a memory. The controller determines whether the first supply reel or the second supply reel is attached to the housing body by reading information from the memory.

Further, the controller determines whether the first supply reel or the second supply reel is attached based on the information in the memory, so that the user does not need to input an instruction to the layer transfer device regarding the type of the supply reel.

The viscoelastic layer may have a thickness of 20 μm to 50 μm.

Further, the layer transfer device may further include a pressure rotating member, a switching mechanism, a peeling member, an upstream conveying roller, and a controller.

The pressure rotating member transfers the viscoelastic layer of the film to the printed layer of the sheet by conveying the film and the sheet sandwiched between the pressure rotating member and the heating rotating member.

The switching mechanism switches a state of the heating rotating member and the pressure rotating member between a pressure state in which the film is sandwiched between the heating rotating member and the pressure rotating member, and a separated state in which at least one of the heating rotating member and the pressure rotating member is separated from the film.

The peeling member peels the film conveyed from the heating rotating member and the pressure rotating member from the sheet.

The upstream conveying roller configured to supply the sheet toward the heating rotating member and the pressure rotating member.

The controller can execute a conveying process and a switching process.

In the conveying process, the controller controls the upstream conveying roller to convey the sheet toward the heating rotating member and the pressure rotating member, which are in the separated state. In the switching process, the controller controls the switching mechanism to switch the heating rotating member and the pressure rotating member from the separated state to the pressure state.

At a time point when the heating rotating member and the pressure rotating member are brought into the pressure state by the switching process, a leading end of the sheet is positioned downstream of a nip portion between the heating rotating member and the pressure rotating member in a conveying direction of the sheet, and a trailing end of the sheet is positioned upstream of the nip portion in the conveying direction.

By adopting a configuration in which the leading end of the sheet is positioned on the downstream side of the nip portion between the heating rotating member and the pressure rotating member in the conveying direction of the sheet and the trailing end of the sheet is positioned on the upstream side of the nip portion in the conveying direction at the time when the heating rotating member and the pressure rotating member are in the pressure state, the leading end of the sheet is not bonded to the viscoelastic layer film, and thus the viscoelastic layer film can be more reliably peeled off from the sheet.

Further, the layer transfer device may further include a downstream conveying roller.

The downstream conveying roller is positioned downstream of the peeling member in the conveying direction. The downstream conveying roller conveys the sheet.

In this case, the controller may execute a peeling process in which the heating rotating member and the pressure rotating member are kept in the pressure state and rotated until a trailing end of a sheet being conveyed by the downstream conveying roller passes through the peeling member, and after the trailing end of the sheet passes through the peeling member, the heating rotating member and the pressure rotating member are switched from the pressure state to the separated state.

By keeping the heating rotating member and the pressure rotating member in the pressure state and rotating the heating rotating member and the pressure rotating member until the trailing end of the sheet being conveyed by the downstream conveying roller passes through the peeling member, the sheet and the film can be conveyed by the heating rotating member and the pressure rotating member until the peeling of a portion near the trailing end of the sheet is completed, so that the film can be peeled from the sheet more reliably.

Further, the layer transfer device may further include a supply reel around which the film is wound, and a take-up reel configured to take up the film supplied from the supply reel.

Further, the layer transfer device may further include a supply roller configured to convey the sheet toward the upstream conveying roller.

In this case, the controller may execute a conveying process and a switching process.

In the conveying process, the controller conveys the sheet toward the heating rotating member and the pressure rotating member in the separated state by driving the supply roller and the upstream conveying roller.

In the switching process, the controller switches the heating rotating member and the pressure rotating member from the separated state to the pressure state.

The controller continuously drives the supply roller and the upstream conveying roller until the sheet reaches between the heating rotating member and the pressure rotating member.

In the configuration provided with the supply reel and the take-up reel, the sheet traveling from the upstream conveying roller toward the heating rotating member or the like encounters resistance by coming into contact with the viscoelastic layer of the film in a stationary state. At this time, if the supply roller is stopped, the supply roller also acts as a resistance to the movement of the sheet. Therefore, by adopting a configuration in which the driving of the supply roller and the upstream conveying roller is continued until the sheet reaches between the heating rotating member and the pressure rotating member, the supply roller can be prevented from acting as a resistance to the movement of the sheet, and therefore, even if the sheet comes into contact with the viscoelastic layer of the film, it is possible to convey the sheet by the supply roller and the upstream conveying roller without being affected by the resistance of the viscoelastic layer of the film.

Further, the layer transfer device may further include a fan configured to cool an inside of the housing body.

In this case, the controller stops the fan while a layer transfer process is being performed to transfer the viscoelastic layer of the film to the printed layer of the sheet.

By adopting a configuration in which the fan is stopped while the layer transfer process is being performed, it is possible to prevent a transfer failure caused by the excessively low temperature of the viscoelastic layer.

The sheet may have a first base layer, a first release layer formed on the first base layer, and the printed layer formed on the first release layer.

Further, the film may have a second base layer, a second release layer formed on the second base layer, and the viscoelastic layer formed on the second release layer.

When a layer transfer process of transferring the viscoelastic layer of the film to the printed layer of the sheet is performed continuously on a plurality of sheets, the controller executes the peeling process for each sheet.

According to the present invention, when transferring a viscoelastic layer to a printed layer of a sheet, it is possible to eliminate the effort required for a user to manually peel off a base layer that has been supporting the viscoelastic layer.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A layer transfer device comprising:
a housing body;
a first supply reel detachably attached to the housing body, the first supply reel including a winding core around which a film is wound, the film including a first base layer, a first release layer formed on the first base layer, and a viscoelastic layer formed on the first release layer;
a take-up reel configured to take up the film supplied from the first supply reel;
a motor configured to drive the take-up reel; and
a transfer unit including a heating rotating member and configured to overlay a sheet including a second base layer and a printed layer printed on the second base layer on the film supplied from the first supply reel, and heat the sheet with the heating rotating member to transfer the viscoelastic layer of the film to the printed layer of the sheet.

2. The layer transfer device according to claim 1,
wherein the film is wound around the first supply reel such that the viscoelastic layer faces the winding core of the first supply reel.

3. The layer transfer device according to claim 1,
wherein the sheet further includes a second release layer between the second base layer and the printed layer, and
wherein at a first temperature which is a temperature at which the first base layer is peelable from the viscoelastic layer, a first peeling force of the first release layer, which is a force required to peel off the first base layer from the viscoelastic layer, is smaller than a second peeling force of the second release layer, which is a force required to peel off the second base layer from the printed layer.

4. The layer transfer device according to claim 3,
wherein a second supply reel, around which a foil film including a foil is wound, is attached to the housing body instead of the first supply reel, and
wherein the transfer unit is configured to overlay a sheet on the foil film supplied from the second supply reel to transfer the foil to a printed layer formed on the sheet.

5. The layer transfer device according to claim 4, further comprising:
a controller,
wherein the controller is configured to
when the first supply reel is attached to the housing body, control the film to be at the first temperature at a peeling position where the first base layer is to be peeled off from the viscoelastic layer, and
when the second supply reel is attached to the housing body, control the foil film to be at a second temperature different from the first temperature at a peeling position where the base layer is to be peeled off from the foil film.

6. The layer transfer device according to claim 5,
wherein the second temperature is lower than the first temperature.

7. The layer transfer device according to claim 5,
wherein the controller controls a temperature of the heating rotating member to control a temperature of the film at the peeling position to the first temperature and to control a temperature of the foil film at the peeling position to the second temperature.

8. The layer transfer device according to claim 5, further comprising:
a fan configured to exhaust air in the housing body to an outside of the housing body,
wherein the controller drives or stops the fan to control a temperature of the film at the peeling position to the first temperature and to control a temperature of the foil film at the peeling position to the second temperature.

9. The layer transfer device according to claim 5, further comprising:
a frame that covers the heating rotating member,
wherein the frame has a frame opening formed at a position where heat generated by the heating rotating member reaches the peeling position.

10. The layer transfer device according to claim 1, further comprising:
a torque limiter configured to limit torque of a driving force supplied from the motor to the take-up reel,
wherein the torque limiter applies, to the take-up reel, torque of a magnitude large enough to peel off the first base layer from the viscoelastic layer.

11. The layer transfer device according to claim 1, further comprising:
a peeling shaft configured to guide the first base layer of the film that has passed through the transfer unit in a direction different from a conveying direction of a sheet,
wherein a radius of curvature of the peeling shaft at a portion where the film is wrapped is 1 mm to 3 mm.

12. The layer transfer device according to claim 11,
wherein a wrapping angle of the film around the peeling shaft is an obtuse angle.

13. The layer transfer device according to claim 5,
wherein the first supply reel and the second supply reel each include a memory, and
wherein the controller determines whether the first supply reel or the second supply reel is attached to the housing body by reading information from the memory.

14. The layer transfer device according to claim 1,
wherein the viscoelastic layer has a thickness of 20 μm to 50 μm.

15. The layer transfer device according to claim 1, further comprising:
a pressure rotating member configured to transfer the viscoelastic layer of the film to the printed layer of the sheet by conveying the film and the sheet sandwiched between the pressure rotating member and the heating rotating member;
a switching mechanism configured to switch a state of the heating rotating member and the pressure rotating member between a pressure state in which the film is sandwiched between the heating rotating member and the pressure rotating member, and a separated state in which at least one of the heating rotating member and the pressure rotating member is separated from the film;
a peeling member configured to peel the film conveyed from the heating rotating member and the pressure rotating member from the sheet;
an upstream conveying roller configured to supply the sheet toward the heating rotating member and the pressure rotating member; and
a controller,
wherein the controller is configured to execute
a conveying process of controlling the upstream conveying roller to convey the sheet toward the heating rotating member and the pressure rotating member, which are in the separated state, and
a switching process of controlling the switching mechanism to switch the heating rotating member and the pressure rotating member from the separated state to the pressure state, and
wherein at a time point when the heating rotating member and the pressure rotating member are brought into the pressure state by the switching process, a leading end of the sheet is positioned downstream of a nip portion between the heating rotating member and the pressure rotating member in a conveying direction of the sheet, and a trailing end of the sheet is positioned upstream of the nip portion in the conveying direction.

16. The layer transfer device according to claim 15, further comprising:
a downstream conveying roller positioned downstream of the peeling member in the conveying direction and configured to convey the sheet,
wherein the controller is configured to execute a peeling process in which the heating rotating member and the pressure rotating member are kept in the pressure state and rotated until a trailing end of a sheet being conveyed by the downstream conveying roller passes through the peeling member, and after the trailing end of the sheet passes through the peeling member, the heating rotating member and the pressure rotating member are switched from the pressure state to the separated state.

17. The layer transfer device according to claim 15, further comprising:
a supply reel around which the film is wound; and
a take-up reel configured to take up the film supplied from the supply reel.

18. The layer transfer device according to claim 17, further comprising:
a supply roller configured to convey the sheet toward the upstream conveying roller,
wherein the controller is configured to execute
a conveying process of conveying the sheet toward the heating rotating member and the pressure rotating member in the separated state by driving the supply roller and the upstream conveying roller, and
a switching process of switching the heating rotating member and the pressure rotating member from the separated state to the pressure state, and
wherein the supply roller and the upstream conveying roller are continuously driven until the sheet reaches between the heating rotating member and the pressure rotating member.

19. The layer transfer device according to claim 15, further comprising:
a fan configured to cool an inside of the housing body,
wherein the controller stops the fan while a layer transfer process is being performed to transfer the viscoelastic layer of the film to the printed layer of the sheet.

20. The layer transfer device according to claim 15,
wherein the sheet has
a first base layer,
a first release layer formed on the first base layer, and
the printed layer formed on the first release layer.

21. The layer transfer device according to claim 15,
wherein the film has
a second base layer,
a second release layer formed on the second base layer, and
the viscoelastic layer formed on the second release layer.

22. The layer transfer device according to claim 16,
wherein when a layer transfer process of transferring the viscoelastic layer of the film to the printed layer of the sheet is performed continuously on a plurality of sheets, the controller executes the peeling process for each sheet.
